(19) United States
(12) Patent Application Publication
(10) Pub. No.: US 2019/0003411 A1
(43) Pub. Date: Jan. 3, 2019

(54) INFORMATION PROCESSING APPARATUS, FUNCTION PARAMETER SETTING METHOD, AND IN-VEHICLE CONTROL SYSTEM

(71) Applicant: FUJITSU LIMITED, Kawasaki-shi (JP)

(72) Inventors: NORIYASU ASO, Isehara (JP); Masatoshi OGAWA, Zama (JP)

(73) Assignee: FUJITSU LIMITED, Kawasaki-shi (JP)

(21) Appl. No.: 16/122,950

(22) Filed: Sep. 6, 2018

Related U.S. Application Data
(63) Continuation of application No. PCT/JP2016/057821, filed on Mar. 11, 2016.

(51) Int. Cl. F02D 41/14; F02D 41/00

(52) U.S. Cl. CPC F02D 41/1402; F02D 41/009; F02D 2250/18; F02D 2041/1433; F02D 2200/024

(57) ABSTRACT

An information processing apparatus includes a memory and a processor coupled to the memory and configured to add a positive value to a first heat release rate based on an actually measured value of an in-cylinder pressure of an internal combustion engine for each crank angle of the internal combustion engine to derive a second heat release rate according to the crank angle, set a plurality of first model parameters of a Wiebe function which models a heat release rate based on the second heat release rate, store the first model parameters in the memory, and output the first model parameters from the memory in order to calculate a torque which controls the internal combustion engine at the time of actual operation of the internal combustion engine.

### CROSS-REFERENCE TO RELATED APPLICATION

This application is a continuation application of International Application PCT/JP2016/057821 filed on Mar. 11, 2016 and designated the U.S., the entire contents of which are incorporated herein by reference.

### FIELD

The embodiment discussed herein is related to an information processing apparatus, a function parameter setting method, and an in-vehicle control system.

### BACKGROUND

The heat release rate due to combustion in a cylinder of an internal combustion engine is modeled by the Wiebe function.

A related technique is disclosed in Japanese Laid-open Patent Publication No. 2008-215204.

### SUMMARY

According to an aspect of the embodiment, an information processing apparatus includes: a memory; and a processor coupled to the memory and configured to: add a positive value to a first heat release rate based on an actually measured value of an in-cylinder pressure of an internal combustion engine for each crank angle of the internal combustion engine to derive a second heat release rate according to the crank angle; set a plurality of first model parameters of a Wiebe function which models a heat release rate based on the second heat release rate; store the first model parameters in the memory; and output the first model parameters from the memory in order to calculate a torque which controls the internal combustion engine at the time of actual operation of the internal combustion engine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating a relationship between a Wiebe function and a combustion rate;

FIG. 1B is a diagram illustrating a relationship between the Wiebe function and a heat release rate;

FIG. 2 is a diagram illustrating an example of heat loss characteristics (a relationship between a crank angle and a heat loss);

FIG. 3 is a diagram illustrating a relationship between the Wiebe function and the heat release rate in the case of three-stage injection;

FIG. 4 is a diagram illustrating an example of a waveform of an apparent heat release rate ROHR calculated from an in-cylinder pressure;

FIG. 5 is an explanatory diagram for schematically describing a schematic flow of a Wiebe function parameter identification method according to the present example;

FIG. 6 is an explanatory diagram of identification results by a comparative example;

FIG. 7 is an enlarged diagram of the portion X1 in FIG. 6;

FIG. 8 is an explanatory diagram of identification results according to the present example;

FIG. 9 is an enlarged diagram of the portion X1 in FIG. 8;

FIG. 10 is an explanatory diagram of a heat loss model;

FIG. 11 is a diagram illustrating an example of an in-vehicle control system 1 including a parameter identification device;

FIG. 12 is a diagram illustrating an example of driving data;

FIG. 13 is a diagram illustrating an example of a hardware configuration of the parameter identification device 10;

FIG. 14 is a diagram conceptually illustrating an example of data in a model parameter storage unit 16;

FIG. 15A is an explanatory diagram of the effect of the identification results of the heat loss model according to the present example;

FIG. 15B is an explanatory diagram of the effect of the identification results of the heat loss model according to the present example;

FIG. 16 is a flowchart illustrating an example of processing executed by the parameter identification device 10;

FIG. 17 is a flowchart illustrating an example of processing executed by an engine control device 30;

FIG. 18 is an explanatory diagram for schematically describing a general flow of operations of the parameter identification device 10 and the engine control device 30 in the in-vehicle control system 1; and

FIG. 19 is a diagram illustrating another example of the in-vehicle control system including the parameter identification device.

### DESCRIPTION OF EMBODIMENT

Since a heat loss occurs in an actual cylinder of an internal combustion engine, a heat release rate (apparent heat release rate) based on an actually measured value of an in-cylinder pressure may be negative at a specific crank angle. However, since the Wiebe function may not express a region where the apparent heat release rate becomes negative (that is, a region where a heat loss greater than a heat release rate occurs), it may be difficult to accurately reproduce the apparent heat release rate corresponding to the measured in-cylinder pressure by using the Wiebe function.

For example, a Wiebe function parameter identification device or the like capable of accurately reproducing an apparent heat release rate corresponding to a measured in-cylinder pressure may be provided.

Hereinafter, each embodiment will be described in detail with reference to the attached drawings.

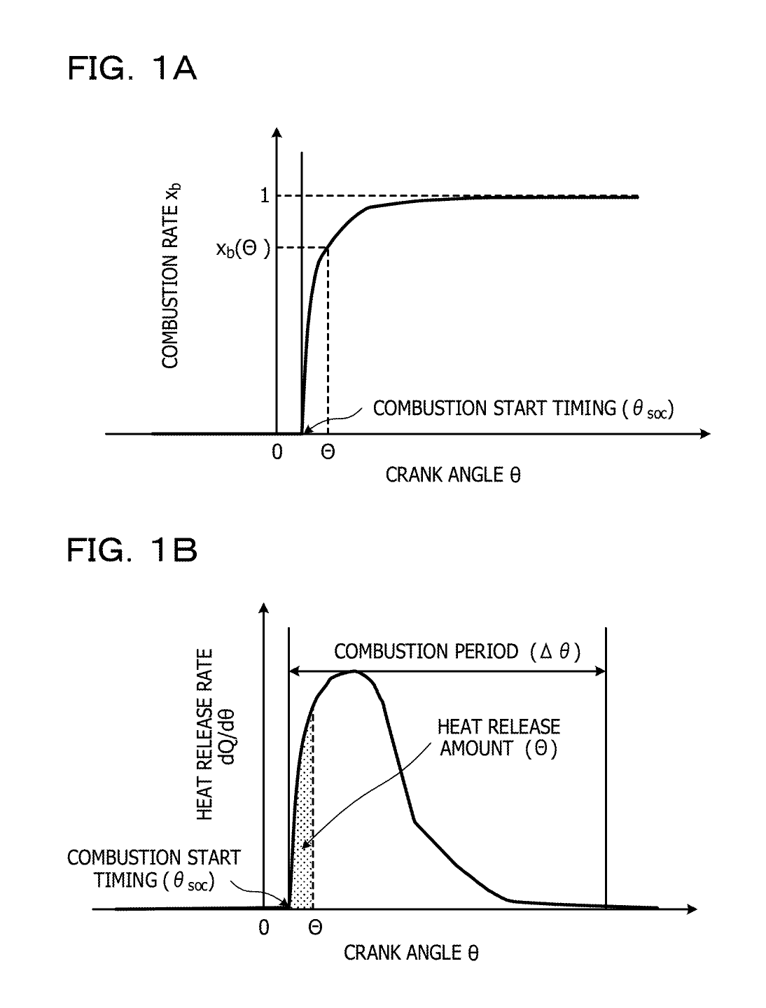

First, basic items of the Wiebe function will be described with reference to FIGS. 1A and 1B.

FIG. 1A is a diagram illustrating a relationship between a Wiebe function and a combustion rate. FIG. 1B is a diagram illustrating a relationship between the Wiebe function and a heat release rate.

The Wiebe function is known as an approximate function of a heat release pattern (combustion waveform). Specifically, the Wiebe function is a function that approximates the profile of a combustion rate x_{b} calculated from a combustion pressure and is given by the following expression with respect to a crank angle θ.

$${x}_{b} ( θ ) = 1 - exp \{ - a \cdot {[ \frac{θ - {θ}_{soc}}{Δθ} ]}^{m + 1} \} \qquad ( 1 )$$

Here, a and m are shape indices, θ_{soc} is a combustion start timing, and Δθ is a combustion period, respectively. The four parameters a, m, θ_{soc}, and Δθ are called Wiebe function parameters. In FIG. 1A, the relationship between the Wiebe function and the combustion rate x_{b} is illustrated, the horizontal axis is the crank angle θ, and the vertical axis is the combustion rate x_{b}. By using these four Wiebe function parameters, the heat release rate (Rate of Heat Release) ROHR_{w} in the cylinder is expressed by the following equation.

$${ROHR}_{w} = \frac{dQ}{d θ} = {Q}_{b} \cdot a \cdot ( m + 1 ) \frac{1}{Δθ} \cdot {[ \frac{θ - {θ}_{soc}}{Δθ} ]}^{m} \cdot exp \{ - a \cdot {[ \frac{θ - {θ}_{soc}}{Δθ} ]}^{m + 1} \} \qquad ( 2 )$$

Here, Q_{b} is a total heat release amount in the cylinder. As the value of the total heat release amount Q_{b}, a value calculated based on a fuel injection amount or the like may be used. At the same time, the total heat release amount generated from the combustion start timing θ_{soc} to a certain timing θ is expressed by the following equation.

HR_{w}(θ)=∫_{θ}_{_{soc}}^{Θ}ROHR_{w}dθ (3)

In FIG. 1B, the relationship between the Wiebe function and a heat release rate dQ_{b}/dθ is illustrated, the horizontal axis is the crank angle θ, and the vertical axis is the heat release rate dQ_{b}/dθ. In FIG. 1B, a total heat release amount HR(θ) when the crank angle θ=θ is indicated by a hatched range.

Here, in Equation 2, when it is assumed that the values of the Wiebe function parameters to be identified are the values of the four Wiebe function parameters of a, m, θ_{soc}, and Δθ, the number of the values of the Wiebe function parameters to be identified is 4. The value of a combustion ratio xf may also be included in the values of the Wiebe function parameters to be identified. In addition, for example, the Wiebe function parameter a may be set to a fixed value such as 6.9. In the following, the values of these Wiebe function parameters a, m, θ_{soc}, and Δθ are referred to as a value, m value, θ_{soc} value, and Δθ value, respectively.

The value of each Wiebe function parameter such as a value, m value, θ_{soc} value, and Δθ value is identified, for example, such that an error between ROHRₜᵣᵤₑ and ROHR_{w} is minimized. Specifically, an evaluation equation (evaluation function) for identifying the values of the Wiebe function parameters is as follows. In this case, the value of each Wiebe function parameter is identified so that the sum of squared errors between ROHRₜᵣᵤₑ and ROHR_{w} is minimized. At this time, the value of each Wiebe function parameter that minimizes an evaluation function F may be derived by optimization calculation using an interior point method, a sequential programming method, or the like.

F=min{Σ(ROHRₜᵣᵤₑ−ROHR_{w})²} (4)

Here, ROHRₜᵣᵤₑ is the heat release rate obtained by adding a heat loss HL_{actual} to the apparent heat release rate ROHRₐₚₚₐᵣₑₙₜ based on driving data (actually measured in-cylinder pressure), hereinafter also referred to as a “true heat release rate”. ROHR_{w} is the heat release rate obtained from the Wiebe function. Σ represents the integration at each crank angle during one cycle or during the combustion period, for example. A true heat release rate ROHRₜᵣᵤₑ may be calculated, for example, as follows.

ROHRₜᵣᵤₑ=ROHRₐₚₚₐᵣₑₙₜ+HL_{actual} (5)

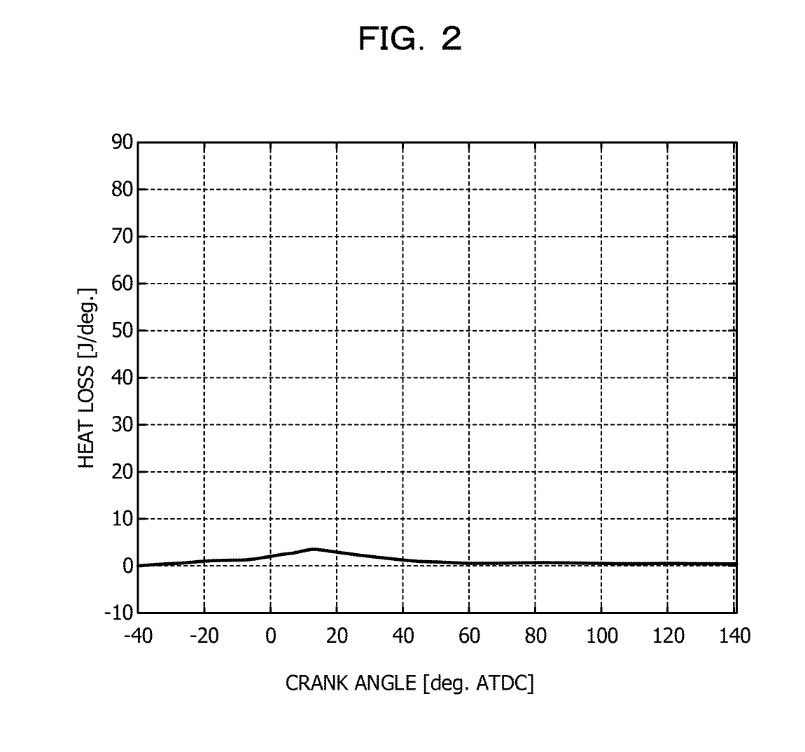

Here, HL_{actual} represents a heat loss. The heat loss is a negative value in relation to the heat release rate, but here treated as a positive value. That is, HL_{actual} (and also HL_{calc} to be described later) is a positive value. The heat loss HL_{actual}, as illustrated in FIG. 2, varies according to the crank angle. The heat loss HL_{actual} may be derived based on driving data (measured in-cylinder pressure data). For example, the heat loss HL_{actual}(θ) according to the crank angle may be derived by an empirical equation that predicts an average heat transfer coefficient on the cylinder wall surface by using the measured in-cylinder pressure data. For example, it is known that the heat transfer coefficient to the cylinder wall surface may be expressed by the following.

h=C·d^{m-1}·P^{m}·W^{m}·T^{0.75-1.62m} (6)

Here, C is an experimental constant, W is an effect of gas flow in a combustion chamber, and d is a bore diameter. As an empirical equation in which 0.8 is used for m, the following is known.

h_{g}=0.456·d^{0.2}·P^{0.8}·W^{0.8}·T^{-0.53} (7)

By using these heat transfer coefficients, the heat loss HL_{actual} may be expressed by the following equation.

$${HL}_{actual} = \frac{dQ}{dt} = {h}_{g} \cdot {A}_{w} \cdot ( T - {T}_{w} ) \cdot ( 2 π N / 60 ) \qquad ( 8 )$$

Here, T is a gas temperature in the cylinder, T_{w} is a wall temperature of the cylinder wall surface, N is an engine speed, A_{w} is a cylinder wall area, and P is an in-cylinder pressure. t is time, which is substantially equivalent to the crank angle θ. As the value of P, a value (value corresponding to the crank angle θ) based on the measured in-cylinder pressure data is used.

In addition, the apparent heat release rate ROHRₐₚₚₐᵣₑₙₜ may be derived by using the following relationship based on an actually measured in-cylinder pressure data obtained in a test.

$${ROHR}_{apparent} = ( \frac{1}{γ - 1} ) V \frac{dP}{d θ} + ( \frac{γ}{γ - 1} ) P \frac{dV}{d θ} \qquad ( 9 )$$

Here, Q is a heat release amount, γ is a specific heat ratio, P is the in-cylinder pressure, and V is an in-cylinder volume. For example, as the value of γ, a known value determined based on the composition of the combustion gas or the like may be used. Similarly, a value based on the measured in-cylinder pressure data is used as the value of P. A value geometrically determined according to the crank angle θ may be used for each of the in-cylinder volume V and the change rate thereof dV/dθ.

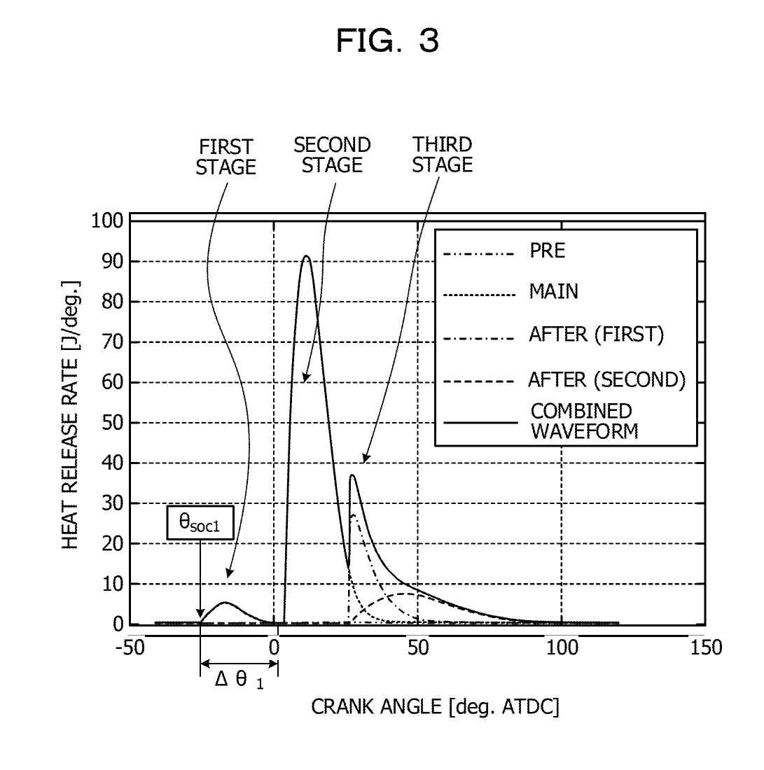

In the modeling methods using the Wiebe function, there is also a modeling method using a combination of plural Wiebe functions. For example, since the heat release rate in the case of multi-stage injection such as a diesel engine is obtained by superimposing the heat release rates of each stage, it is possible to accurately express the heat release by using a plurality of Wiebe functions. FIG. 3 illustrates a waveform (hereinafter, also referred to as “combustion waveform”) illustrating a relationship between the crank angle θ and the heat release rate in the case of a diesel engine performing three-stage injection. In FIG. 3, a combustion waveform relating to pre-combustion by a first stage injection, a combustion waveform relating to the main combustion by a second stage injection, each combustion waveform relating to the first combustion and the second combustion (diffusion combustion) by after-combustion of a third stage injection, and the combined waveform thereof are illustrated.

For example, in the case of three-stage injection as illustrated in FIG. 3, for example, a modeling method using a combination of N+1 Wiebe functions may be used as follows. In this case, N=3, and a combination of four Wiebe functions may be used. That is, N corresponds to the number of injections.

$$\begin{matrix}{ROHR}_{w} = {\sum }_{i = 1}^{N + 1} {ROHR}_{i} \\ = {\sum }_{i = 1}^{N + 1} Q \cdot {xf}_{i} \cdot \frac{{dx}_{b}}{d θ} \\ = {\sum }_{i = 1}^{N + 1} Q \cdot {xf}_{i} \cdot {a}_{i} ( {m}_{i} + 1 ) \cdot \frac{1}{{Δθ}_{i}} \cdot {[ \frac{θ - {θ}_{{soc}_{i}}}{{Δθ}_{i}} ]}^{{m}_{i}} \cdot \\ exp \{ - {a}_{i} \cdot {[ \frac{θ - {θ}_{{soc}_{i}}}{{Δθ}_{i}} ]}^{{m}_{i} + 1} \}\end{matrix} \qquad ( 10 )$$

Here, xf is a combustion ratio. Equation 10 corresponds to an equation obtained by combining N+1 Equations 2 multiplied by the combustion ratio xf. That is, Equation 10 corresponds to an equation obtained by combining N+1 Wiebe functions (k is an arbitrary number from 1 to N+1) relating to i=k multiplied by the combustion ratio xf.

According to such a modeling method using a combination of Wiebe functions, even in a case where there are a plurality of combustion modes of different combustion types in one cycle, it is possible to model with high accuracy. For example, a modeling method of Equation 10 is suitable in a case where there are N+1 combustion modes of different combustion types in one cycle. The combustion mode of different combustion types is, for example, a combustion mode in which the relationship between the crank angle θ and the heat release rate is significantly different as illustrated in FIG. 1B. In the case of multi-stage injection like the latest diesel engine, since the heat release rate is obtained by superimposing the heat release rate of each stage, a modeling method using a combination of Wiebe functions is useful. However, not only in a diesel engine, but also in a gasoline engine and the like, there may be cases where there are a plurality of combustion modes of different combustion types in one cycle. Therefore, the modeling method using the combination of Wiebe functions may also be applied to other engines such as a gasoline engine and the like.

Here, in Equation 10, when it is assumed that the values of the Wiebe function parameters to be identified are the values of the four Wiebe function parameters of a, m, θ_{soc}, and Δθ, since there are N+1 Wiebe functions, the number of the values of the Wiebe function parameters to be identified is 4×(N+1). The value of a combustion ratio xf may also be included in the values of the Wiebe function parameters to be identified. In addition, for example, the Wiebe function parameter a may be set to a fixed value such as 6.9.

Also in the case of the combination of Wiebe functions, similarly, the evaluation function F illustrated in Equation 4 may be used as an evaluation equation (evaluation function) for identifying the values of the Wiebe function parameters. In this case, the heat release rate ROHR_{w} is calculated based on Equation 10. Alternatively, in order to improve the accuracy of parameter identification, the sum of squared errors of the heat release amount HR, a difference in the m value between the Wiebe functions for each of two combustion modes of different combustion types, a difference in the Δθ value between the same Wiebe functions, and the like may be included. For example, in this case, the evaluation function F may be, for example, as follows.

F=min{Σ(ROHRₜᵣᵤₑ−ROHR_{w})²+w₁·Σ(HRₜᵣᵤₑ−HR_{w})²−w₂·(mᵢ−mₖ)²} (11)

In Expression 11, Σ represents the integration at each crank angle during one cycle or during the combustion period, for example. Here, the first term in the curly bracket is an evaluation value relating to the heat release rate (ROHR), which is the same as the evaluation function F illustrated in the Equation 4 described above. However, in this case, the heat release rate ROHR_{w} is calculated based on Equation 10. The second term in the curly bracket is an evaluation value relating to the sum of squared errors of the heat release amount HR. HRw is obtained from Equation 3. However, in this case, ROHR_{w} of Equation 3 is based on Equation 10. HRₜᵣᵤₑ is as follows. The third term in the curly bracket is an evaluation value relating to the difference between the m value of the Wiebe function relating to an i-th combustion mode and the m value of the Wiebe function relating to a k-th combustion mode. w₁ and w₂ are weights.

HRₜᵣᵤₑ(Θ)=∫_{θ}_{_{soc}}^{Θ}ROHRₜᵣᵤₑdθ (12)

In another embodiment, the evaluation function F may be, for example, as follows.

F=min{Σ(ROHRₜᵣᵤₑ−ROHR_{w})²+w₁·(Δθᵢ−Δθₖ)²−w₂·(mᵢ−mₖ)²} (13)

In the case of the evaluation function F of Equation 13, the second term in the curly bracket is an evaluation value relating to the difference between the Δθ value of the Wiebe function relating to an i-th combustion mode and the Δθ value of the Wiebe function relating to the k-th combustion mode.

Each Wiebe function parameter included in Equation 10 is identified as a value that minimizes the evaluation function F. At this time, the value of each Wiebe function parameter that minimizes an evaluation function F may be derived by optimization calculation using an interior point method, a sequential programming method, or the like. In addition, in the optimization calculation, other constraint conditions may be added. Other constraint conditions include, for example, the sum of combustion ratios xfᵢ being about 1 and a combustion ratio xf of the Wiebe function relating to the main combustion being larger than the combustion ratio xf of the Wiebe function relating to other combustion.

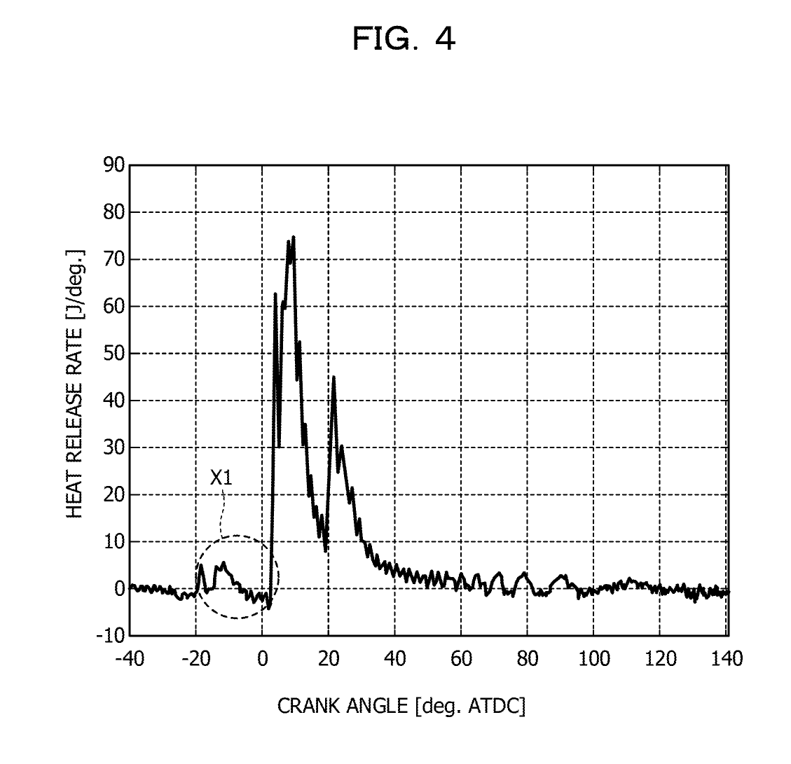

Here, an apparent heat release rate ROHRₐₚₚₐᵣₑₙₜ will be described with reference to FIG. 4. FIG. 4 is a diagram illustrating an example of a waveform of an apparent heat release rate ROHR calculated from actually measured in-cylinder pressure data. As illustrated in the portion X1 in FIG. 4, the apparent heat release rate ROHRₐₚₚₐᵣₑₙₜ may be a negative value because a heat loss in the engine is included. As the heat loss in the engine, there are a heat loss from the cylinder wall surface, ha eat loss caused by injection, and the like.

On the other hand, as illustrated in FIG. 1B and Equation 2, the Wiebe function may not be a negative value and it is not possible to express a region where the apparent heat release rate becomes negative (that is, a region where a heat loss greater than a heat release rate occurs). Therefore, in the case of identifying each value of the Wiebe function parameter by using the apparent heat release rate ROHRₐₚₚₐᵣₑₙₜ that may be a negative value due to a heat loss as it is, it is difficult to accurately reproduce the apparent heat release rate ROHRₐₚₚₐᵣₑₙₜ based on the Wiebe function using each identified value.

On the other hand, according to the present example, as described above, each value of the Wiebe function parameter is identified by using the true heat release rate ROHRₜᵣᵤₑ instead of the apparent heat release rate ROHRₐₚₚₐᵣₑₙₜ. The true heat release rate ROHRₜᵣᵤₑ is calculated by adding the heat loss HL_{actual} to the apparent heat release rate ROHRₐₚₚₐᵣₑₙₜ as described above with reference to Equation 5. Therefore, according to the present example, it is possible to accurately reproduce the apparent heat release rate ROHRₐₚₚₐᵣₑₙₜ based on the Wiebe function. That is, according to the present example, the heat release rate ROHR_{w} obtained from the Wiebe function accurately reproduces the true heat release rate ROHRₜᵣᵤₑ obtained by adding the heat loss HL_{actual} to the apparent heat release rate ROHRₐₚₚₐᵣₑₙₜ. This is because the trueheat release rate ROHRₜᵣᵤₑ is less likely to have a negative region (that is, a region where a heat loss greater than a heat release rate occurs) by the added heat losses HL_{actual} as compared to the apparent heat release rate ROHRₐₚₚₐᵣₑₙₜ. In theory, the true heat release rate ROHRₜᵣᵤₑ has no negative region. Therefore, the identification accuracy of the Wiebe function with respect to the true heat release rate ROHRₜᵣᵤₑ is higher than the identification accuracy of the Wiebe function with respect to the apparent heat release rate ROHRₐₚₚₐᵣₑₙₜ. Therefore, by subtracting the heat loss HL_{calc} which is the calculated value of the heat loss HL_{actual} from the heat release rate ROHR_{w} which accurately reproduces the true heat release rate ROHRₜᵣᵤₑ, it is possible to accurately reproduce the apparent heat release rate ROHRₐₚₚₐᵣₑₙₜ. That is, the apparent heat release rate ROHRₐₚₚₐᵣₑₙₜ may be accurately reproduced from the following equation.

ROHR_{calc}=ROHR_{w}−HL_{calc} (14)

Here, the ROHR_{calc} represents the heat release rate obtained by subtracting the heat loss HL_{calc} from the heat release rate ROHR_{w} obtained based on the Wiebe functions. According to the present example, in this manner, the heat release rate ROHR_{calc} (=ROHR_{w}−HL_{calc}) obtained by using the Wiebe function may be approximated to the apparent ROHRₐₚₚₐᵣₑₙₜ based on the measured in-cylinder pressure data (that is, it is possible to improve the reproducibility of the apparent heat release rate ROHRₐₚₚₐᵣₑₙₜ). As a result, it is possible to improve the accuracy of the calculated value of the in-cylinder pressure that may be calculated based on the heat release rate ROHR_{calc} obtained by using the Wiebe functions.

The heat loss HL_{calc} which is a calculated value of the heat loss HL_{actual} may be calculated by using a heat loss model to be described later. However, it is also possible to hold the heat loss HL_{actual} for each driving condition as map data and use the heat loss HL_{actual} according to the driving condition as the heat loss HL_{calc}. However, the data amount of the map data having the heat loss HL_{actual} for each driving condition may be enormous. In this respect, in a case where the heat loss HL_{calc} is calculated by using the heat loss model to be described later, it is optional to hold the heat loss HL_{actual} for each driving condition as map data.

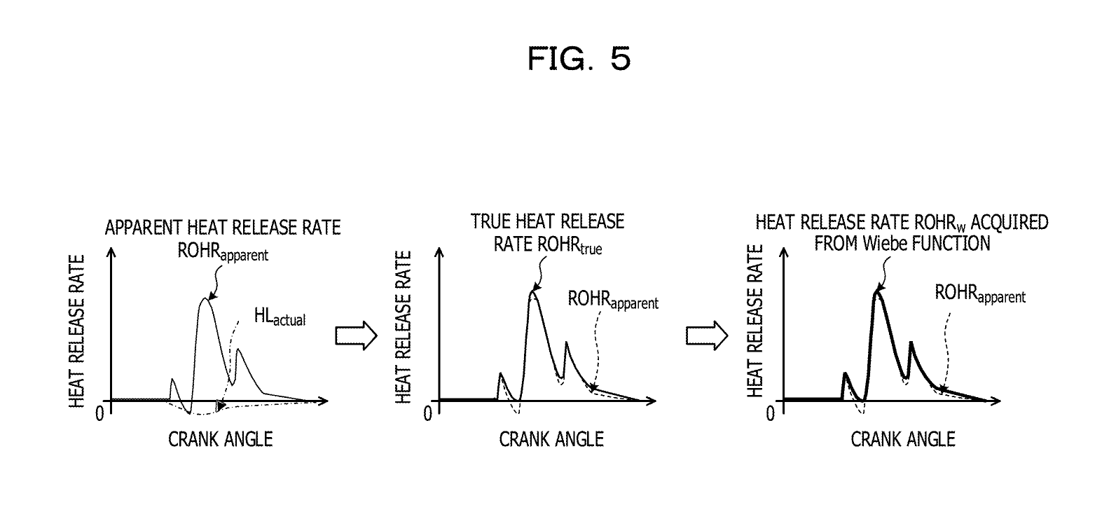

Next, a Wiebe function parameter identification method according to the present example described above with reference to FIG. 5.

FIG. 5 is an explanatory diagram for schematically describing a schematic flow of a Wiebe function parameter identification method according to the present embodiment described above. FIG. 5 illustrates each waveform (a relationship between the crank angle and the heat release rate) relating to the portion X1 in FIG. 4. Specifically, in FIG. 5, from the upstream side in the order of arrows, the apparent relationship (here, referred to as “first relationship”) of the crank angle and the apparent heat release rate ROHRₐₚₚₐᵣₑₙₜ is illustrated firstly. In addition, in FIG. 5, the relationship (here, referred to as “second relationship”) between the crank angle and the true heat release rate ROHRₜᵣᵤₑ is illustrated secondly in the order of the arrows. In addition, in FIG. 5, the relationship (here, referred to as “third relationship”) between the crank angle and the heat release rate ROHR_{w} from the Wiebe function is further illustrated thirdly in the order of the arrows. Furthermore, in FIG. 5, for reference, in the waveform representing the first relationship, a waveform representing the relationship between the crank angle and the negative heat loss −HL_{actual} is illustrated superimposed with a dashed line. In addition, in FIG. 5, for reference, in the waveforms representing the second relationship and the third relationship, a waveform representing the first relationship is superimposed by a dotted line.

First, regarding a certain operating condition, the first relationship (relationship between the crank angle and the apparent heat release rate ROHRₐₚₚₐᵣₑₙₜ) may be obtained based on actually measured in-cylinder pressure data. Next, for the same operating condition, using the relationship (see the dashed line) between the crank angle and the heat loss HL_{actual} based on the measured in-cylinder pressure data and, the value (an example of a predetermined value) of the heat loss HL_{actual} is added to the apparent heat release rate ROHRₐₚₚₐᵣₑₙₜ value based on the first relationship for each crank angle. As a result, the second relationship (the relationship between the crank angle and the true heat release rate ROHRₜᵣᵤₑ) may be obtained. Next, each value of the Wiebe function parameter is identified for the same driving condition. As illustrated in FIG. 5, the third relationship obtained from the Wiebe function by using each value of the identified Wiebe function parameter reproduces the second relationship with high accuracy. In other words, each value of the Wiebe function parameter is identified with respect to the same driving condition so that the third relationship is in agreement with the second relationship.

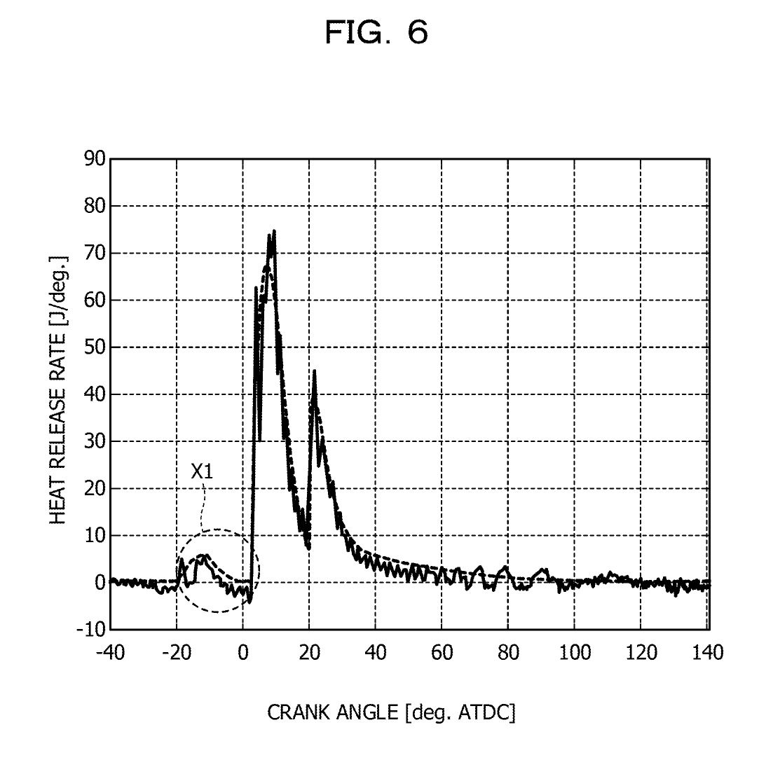

Next, with reference to FIG. 6 to FIG. 9, the effect of the Wiebe function parameter identification method according to the present example described above will be described in comparison with the comparative example.

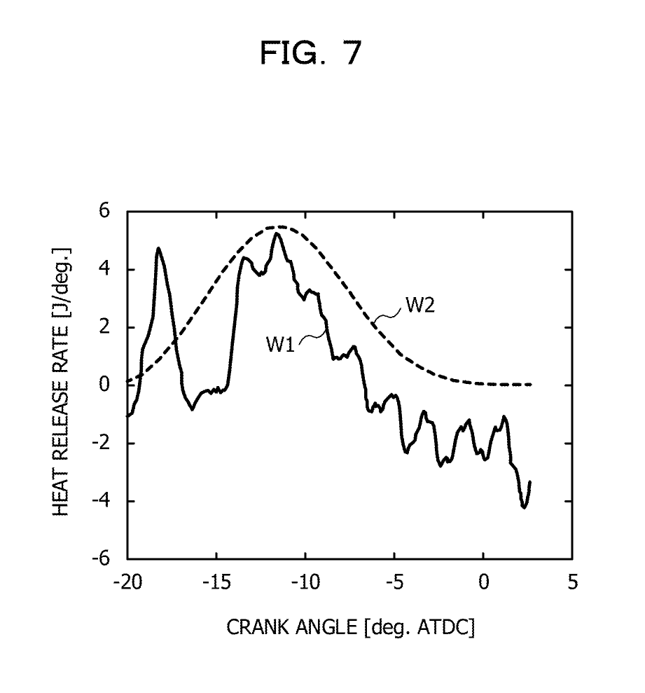

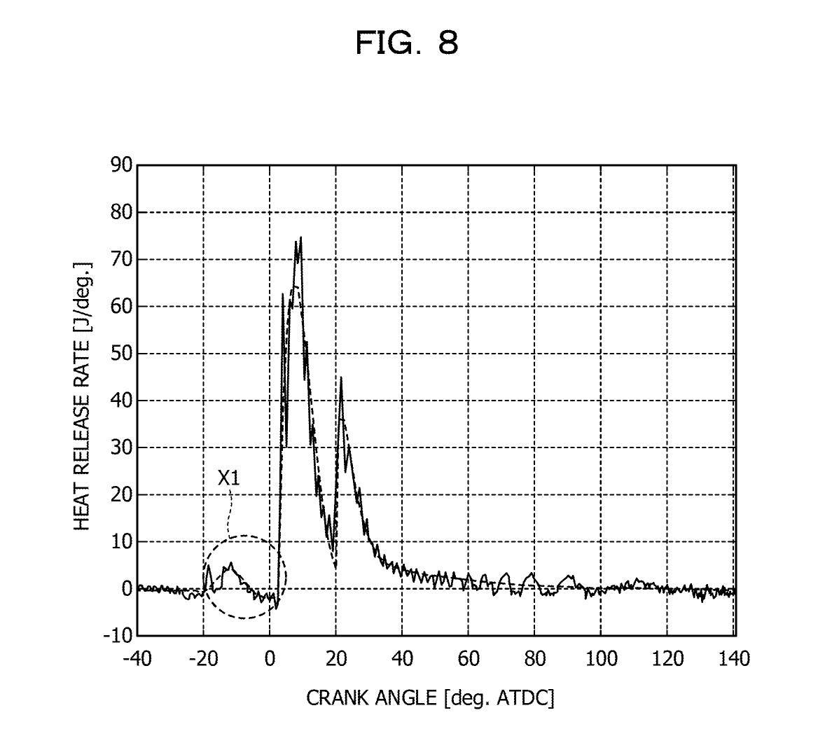

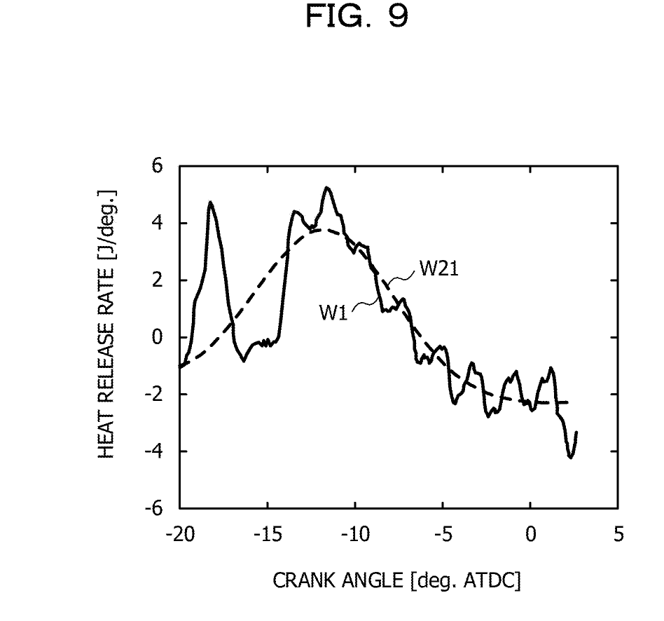

FIGS. 6 and 7 are explanatory diagrams of the identification results according to the comparative example, and FIGS. 8 and 9 are explanatory diagrams of the identification results according to the present example. In FIG. 6, as a waveform representing the relationship between the crank angle and the heat release rate, the waveform W1 relating to the apparent heat release rate ROHRₐₚₚₐᵣₑₙₜ based on the measured in-cylinder pressure data and the waveform W2 relating to the heat release rate ROHR_{w-comparison} obtained from the Wiebe function identified by the identification method according to the comparative example are illustrated. FIG. 7 illustrates an enlarged diagram of the portion X1 in FIG. 6. In FIG. 8, the waveform W1 and the waveform W21 relating to the heat release rate ROHR_{calc} are illustrated as the waveforms representing the relationship between the crank angle and the heat release rate. As described above, the waveform W21 relating to the heat release rate ROHR_{calc} is obtained by subtracting the heat loss HL_{calc} from the heat release rate ROHR_{w} obtained by using the Wiebe function in which each value of the Wiebe function parameter is identified by the identification method according to the present example. FIG. 9 illustrates an enlarged diagram of the portion X1 in FIG. 8.

In the comparative example, each value of the Wiebe function parameter is identified by using the apparent heat release rate ROHRₐₚₚₐᵣₑₙₜ as it is. That is, in the comparative example, each value of the Wiebe function parameter is identified by using the apparent heat release rate ROHRₐₚₚₐᵣₑₙₜ instead of the true heat release rate ROHRₜᵣᵤₑ in Equation 4 described above or the like. In this comparative example, as illustrated in FIGS. 6 and 7, the waveform W2 relating to the heat release rate ROHR_{w-comparison} obtained from the Wiebe function may not conform to the waveform W1 having a negative value.

On the other hand, according to the present example, as illustrated in FIGS. 8 and 9, the waveform W21 relating to the heat release rate ROHR_{calc} may conform to the waveform W1 having a negative value, and it is possible to confirm that the reproducibility is high. As described above, according to the present example, it is possible to accurately reproduce the apparent heat release rate (the apparent heat release rate ROHRₐₚₚₐᵣₑₙₜ) based on the measured in-cylinder pressure by using the Wiebe function. The apparent heat release rate ROHRₐₚₚₐᵣₑₙₜ is calculated based on the measured in-cylinder pressure data obtained in the test as described above. Therefore, the measured in-cylinder pressure may be calculated inversely from the apparent heat release rate ROHRₐₚₚₐᵣₑₙₜ. Therefore, by using the Wiebe function, it is possible to accurately reproduce the apparent heat release rate ROHRₐₚₚₐᵣₑₙₜ, which means that it is possible to calculate the in-cylinder pressure that accurately corresponds to the measured in-cylinder pressure.

As a more specific evaluation, the inventor of the present application compared the waveform W2 according to the comparative example and the waveform W21 according to the present example by the conformity and the root mean square error (RMSE). The degree of conformity is as follows.

conformity:

$$fitrate = ( 1 - \frac{{‖ y - \hat{y} ‖}_{2}}{{‖ y - \overline{y} ‖}_{2}} ) \times 100 \qquad ( 15 )$$

Here,

[Other 1]

y: experimental value, y̅: average value of experimental value y, ŷ: identified value

According to the present embodiment, the degree of conformity of the portion where the heat release rate becomes negative at the crank angle of −30° to 5° was improved, the conformity of the whole was improved from 75.1% to 77.3% as compared with the comparative example, and the RMSE was reduced from 3.37 to 3.07. In addition, according to the present example, particularly in the range of the crank angle of −20° to 3° where the heat release rate becomes negative, the degree of conformity is improved from 2.8% to 43.2% and the RMSE is reduced from 2.35 to 1.37, which is improved greatly compared with the comparative example.

Next, the heat loss model will be described. The heat loss model may be used to obtain the heat loss HL_{calc} which is the calculated value of the heat loss HL_{actual} for each driving condition without using the map data of the heat loss HL_{actual} for each driving condition. As described above, the heat loss HL_{calc} is subtracted from the heat release rate ROHR_{w} in order to obtain the heat release rate ROHR_{calc} (see Equation 14).

The inventor of the present application paid attention to the fact that as a result of confirming many heat loss characteristics (relationship between crank angle and heat loss) under different driving conditions in developing the heat loss model, the heat loss characteristics are greatly affected by the in-cylinder pressure characteristics (relationship between crank angle and in-cylinder pressure). This also coincides with Equation 8 described above.

Furthermore, the inventor of the present application found out that it is effective to use different models after the intake valve is closed until the start of combustion by main injection and the timing when the exhaust valve opens (EVO: Exhaust Valve Open) after the start of combustion by the main injection. Therefore, the heat loss model includes a combination of a first heat loss model (an example of a first function) and a second heat loss model (an example of a second function). The first heat loss model mainly models the heat loss after the intake valve is closed to the start of combustion by the main injection, and the second heat loss model models the heat loss up to the timing at which the exhaust valve opens after the start of combustion by the main injection.

As the first heat loss model, for example, the following model may be used. First, there is a heat loss from the cylinder wall after the intake valve is closed until the combustion by the main injection starts. This heat loss is polytropic change which is intermediate change between isothermal change and adiabatic change. The polytropic change is as follows.

PVⁿ=constant (16)

Here, n is a polytropic exponent.

Accordingly, the following relationship holds between an in-cylinder pressure P_{IVC} and an in-cylinder volume V_{IVC} when the intake valve is closed, and an in-cylinder pressure P(θ) and an in-cylinder volume V(θ) at the crank angle θ.

P_{IVC}·V_{IVC}ⁿ=P(θ)·V(θ)ⁿ (17)

From Equation 17, it is possible to a heat loss as follows after the intake valve is closed until the combustion by the main injection starts. That is, the first heat loss model is, for example, as follows.

$${HL}_{1} ( θ ) = {z}_{1} \times {P}_{IVC} \times {( \frac{{V}_{IVC}}{V ( θ )} )}^{n} \qquad ( 18 )$$

Here, z₁ is one of heat loss parameters of the first heat loss model.

As the second heat loss model, for example, the following model may be used. Up to the timing EVO when the exhaust valve opens after the start of combustion by the main injection, the relationship between the in-cylinder pressure and the heat release rate is as illustrated in Equation 9 described above, and the correlation between the in-cylinder pressure characteristics and the apparent heat release rate characteristics is high. Therefore, the inventor of the present application examined the second heat loss model using the apparent heat release rate characteristics and confirmed that it is effective to use the function expressible by the Wiebe function. This is because the function expressible by the Wiebe function is expressed by parameters including an ignition timing, the combustion period, and the shape indices, and the degree of freedom of the waveform shape due to the shape indices and the combustion period is high. “A function expressible by a Wiebe function” is an expression to be used because the name “Wiebe function” is commonly used as a function representing a heat release rate. In the mathematical expression, the second heat loss model=Wiebe function.

The heat loss characteristics in the period up to the timing EVO when the exhaust valve opens after the start timing of combustion by the main injection are as follows. At the start of combustion, the heat loss increases due to the rapid increase in the amount of heat transfer to the engine wall surface due to the explosive temperature rise since the start of combustion. Thereafter, the heat loss gradually decreases until combustion ends or until the exhaust valve opens. Therefore, as in the apparent heat release rate characteristics, the heat loss characteristics during such a period is important in terms of the combustion period and the ignition timing (start timing of combustion) as the physical quantity and be accurately expressed by using the waveform shape of the heat release rate by the Wiebe function. Therefore, the second heat loss model is, for example, as follows.

$${HL}_{2} ( θ ) = {z}_{2} \times {z}_{3} \times ( {z}_{4} + 1 ) \times \frac{1}{{z}_{5}} {( \frac{θ - {z}_{6}}{{z}_{5}} )}^{{z}_{4}} \times exp ( - {z}_{3} \times {( \frac{θ - {z}_{6}}{{z}_{5}} )}^{{z}_{4} + 1} ) + {HL}_{EVO} \qquad ( 19 )$$

Here, HLEVO is a heat loss when the exhaust valve opens (Exhaust Valve Open), and z_{2˜6} are heat loss parameters. Among the z_{2˜6}, z₅ is the heat loss period after the start of combustion in the heat loss model, and z₆ is the combustion start timing.

In this case, the heat loss model is as a combination of the first heat loss model and the second heat loss model as follows.

HL_{calc}=HL₁(θ)+HL₂(θ) however, HL₂(θ)=0 when θ<z₆ (20)

Here, in Equation 20, the values of the parameters to be identified are the values of the six parameters z_{1˜6}. It is possible to use a design value for V_{IVC}, and experimental values for P_{IVC} and HL_{EVO}.

The values of the parameters z_{1˜6} are identified, for example, so that the error between HL_{actual} and HL_{calc} is minimized. Specifically, the evaluation equation (evaluation function) for identifying the values of the parameters is as illustrated in the following Equation 21. In the case of Equation 21, the value of each parameter is identified so that the sum of squared errors between HL_{actual} and HL_{calc} is minimized. HL_{actual} is the heat loss calculated from Equation 8 based on the measured in-cylinder pressure data obtained in the test.

F_{HL}=min(Σ(HLₜᵣᵤₑ−HL_{calc})²) (21)

Constraint conditions at the time of identifying parameters are arbitrary, but for example, the parameter z₆ is set to be in the vicinity of the start timing of combustion by the main injection, and the range that the parameter z₅ may have may be within the period from z₆ to EVO.

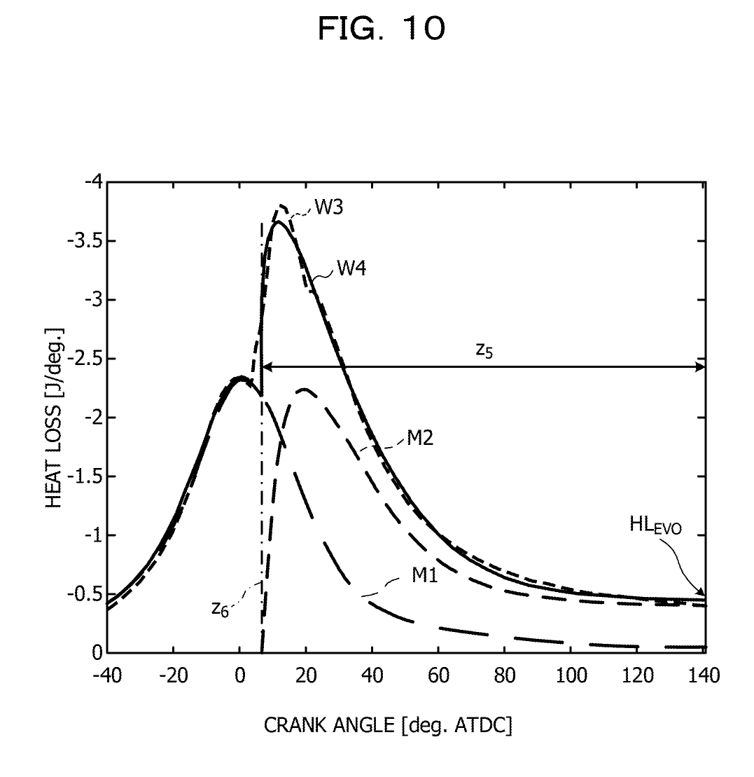

FIG. 10 is an explanatory diagram of the identification results by the heat loss model described above. In FIG. 10, as a waveform representing the relationship between the crank angle and the heat loss, a waveform W3 relating to the heat loss HL_{actual} based on the actually measured in-cylinder pressure data and a waveform W4 relating to the heat loss HL_{calc} obtained from a heat loss model in which parameter values are identified by the identification method according to the present example are illustrated. In addition, in FIG. 10, a first heat loss model M1 and a second heat loss model M2 are schematically illustrated by dotted lines and parameters z₅ and z₆ are schematically illustrated.

According to the heat loss model of the present example, it is possible to identify parameters that characterize the waveform in the heat loss characteristics and to obtain a high degree of conformity to the heat loss HL_{actual} based on the actually measured in-cylinder pressure data. Specifically, as illustrated in FIG. 10, RMSE of 0.045 and conformity of 95.8% indicate high reproducibility for the experimental value based on the measured in-cylinder pressure data.

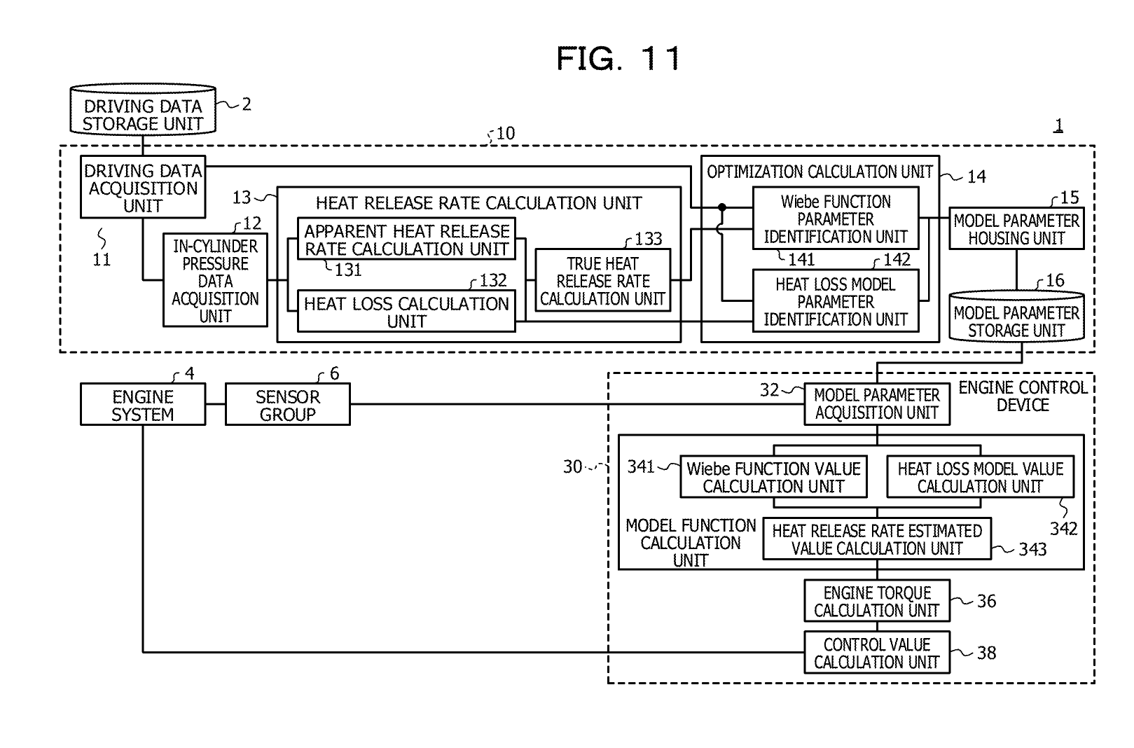

Next, an in-vehicle control system including a parameter identification device using the identification method according to the present example will be described with reference to FIGS. 11 to 16. In the following, for the sake of distinction, the parameters of the Wiebe functions described above are also referred to as “Wiebe function parameters”, and the parameters of the heat loss model parameters described above are also referred to as “heat loss parameters”. In addition, the Wiebe function parameters and the heat loss parameters are collectively referred to as “model parameters” when the parameters are not distinguished.

FIG. 11 is a diagram illustrating an example of the in-vehicle control system 1 including the parameter identification device 10. In addition to the in-vehicle control system 1, a driving data storage unit 2 is also illustrated in FIG. 11.

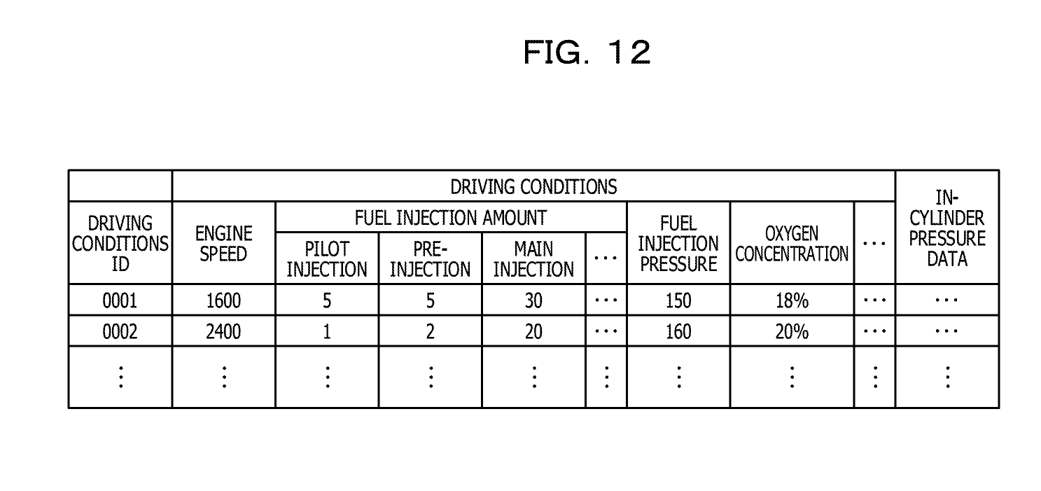

In the driving data storage unit 2, driving data obtained at the time of actual operation of an engine system 4 is stored. The driving data does not have to be data relating to the same system as the engine system 4 but may be data relating to the same engine system including the same type of internal combustion engine. The driving data is each value obtained at the time of actual operation of the engine system 4 and may each value of each predetermined parameter (hereinafter, referred to as “driving condition parameter”) representing a driving condition of the internal combustion engine, actually measured in-cylinder pressure data, and other values (cylinder wall surface temperature and the like) for calculating the heat loss HL_{actual}. The driving data may be obtained by, for example, a bench test with an engine dynamometer facility. The driving condition parameter is a parameter that affects the optimum value of the model parameter. That is, the optimum value of the model parameter changes as each value of the driving condition parameter changes. The measured in-cylinder pressure data is a set of values of the in-cylinder pressure for each crank angle, for example and is collected for each driving condition. For example, FIG. 12 illustrates an example of driving data. In the example illustrated in FIG. 12, the driving condition parameters include an engine speed, a fuel injection amount, a fuel injection pressure, an oxygen concentration and the like, and the fuel injection amount is the value of each injection (in the example illustrated in FIG. 12, pilot injection, pre-injection, and the like). In the example illustrated in FIG. 12, each value of each driving condition parameter and actually measured in-cylinder pressure data are stored in a form associated with a driving condition ID for each driving condition ID (Identification).

The in-vehicle control system 1 illustrated in FIG. 11 is mounted in a vehicle. The vehicle is a vehicle powered by an internal combustion engine and includes a hybrid vehicle powered by an internal combustion engine and an electric motor. The type of the internal combustion engine is arbitrary and may be a diesel engine, a gasoline engine or the like. In addition, the fuel injection system of the gasoline engine is arbitrary and may be a port injection type, an in-cylinder injection type, or a combination thereof.

The in-vehicle control system 1 includes the engine system 4 (an example of a vehicle drive device), a sensor group 6, the parameter identification device 10 (an example of a Wiebe function parameter identification device), and an engine control device 30 (an example of an internal combustion engine state detection device).

The engine system 4 may include various actuators (injector, electronic throttle, starter, and the like) and various members (intake passage, catalyst, and the like) provided in the internal combustion engine.

The sensor group 6 may include various sensors (a crank angle sensor, an air flow meter, an intake pressure sensor, an air-fuel ratio sensor, a temperature sensor, and the like) provided in the internal combustion engine. The sensor group 6 does not have to include an in-cylinder pressure sensor. Installation of the in-cylinder pressure sensor is disadvantageous from the viewpoints of cost, durability, and maintainability.

The parameter identification device 10 identifies the model parameters by the identification method according to the present example as described above based on the driving data in the driving data storage unit 2.

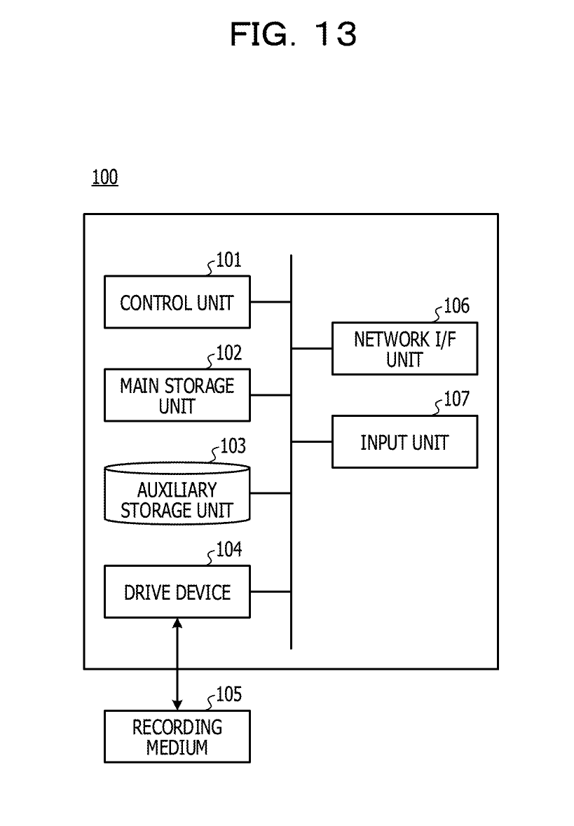

FIG. 13 is a diagram illustrating an example of a hardware configuration of the parameter identification device 10.

In the example illustrated in FIG. 13, the parameter identification device 10 includes a control unit 101, a main storage unit 102, an auxiliary storage unit 103, a drive device 104, a network I/F unit 106, and an input unit 107.

The control unit 101 is an arithmetic unit that executes a program stored in the main storage unit 102 or the auxiliary storage unit 103 and receives data from the input unit 107 and the storage device, calculates and processes the data, and outputs the data to a storage device or the like.

The main storage unit 102 is a read-only memory (ROM), a random-access memory (RAM), or the like. The main storage unit 102 is a storage device that stores or temporarily holds programs such as an operation system (OS) and application software which are basic software executed by the control unit 101 and data.

The auxiliary storage unit 103 is a hard disk drive (HDD) or the like and is a storage device that stores data relating to application software and the like.

The drive device 104 reads a program from the recording medium 105, for example, a flexible disk and installs the program in the storage device.

The recording medium 105 stores a predetermined program. The program stored in the recording medium 105 is installed in the parameter identification device 10 via the drive device 104. The predetermined program installed may be executed by the parameter identification device 10.

The network I/F unit 106 is an interface between the parameter identification device 10 and a peripheral device having a communication function connected via a network constructed by a data transmission path such as a wired and/or a wireless line.

The input unit 107 may be, for example, a user interface provided in a console box or an instrument panel.

In the example illustrated in FIG. 13, various kinds of processing and the like described below may be realized by causing the parameter identification device 10 to execute a program. In addition, it is also possible to record the program in the recording medium 105 and cause the parameter identification device 10 to read the recording medium 105 in which the program is recorded so as to realize various kinds of processing and the like to be described below. As the recording medium 105, various types of recording media may be used. For example, the recording medium 105 may be a recording medium for optically, electrically or magnetically recording information, such as a compact disc (CD)-ROM, a flexible disk, a magneto-optical disk, or the like or may be a semiconductor memory or the like for electrically recording information such as a ROM, a flash memory, or the like. The recording medium 105 does not include a carrier wave. Refer to FIG. 11 again. The parameter identification device 10 includes a driving data acquisition unit 11, an in-cylinder pressure data acquisition unit 12, a heat release rate calculation unit 13, and an optimization calculation unit 14. In addition, the parameter identification device 10 includes the model parameter housing unit 15 (an example of a first relational expression derivation unit and a second relational expression derivation unit) and a model parameter storage unit 16 (an example of a first storage unit and a second storage unit). The heat release rate calculation unit 13 includes an apparent heat release rate calculation unit 131, a heat loss calculation unit 132, and a true heat release rate calculation unit 133 (an example of a predetermined value addition unit). The optimization calculation unit 14 includes a Wiebe function parameter identification unit 141 (an example of a first identification unit) and a heat loss model parameter identification unit 142 (an example of a second identification unit).

The driving data acquisition unit 11, the in-cylinder pressure data acquisition unit 12, the heat release rate calculation unit 13, the optimization calculation unit 14, and the model parameter housing unit 15 are realized, for example by the control unit 101 illustrated in FIG. 13 executing one or more programs in the main storage unit 102 and the like. In addition, the model parameter storage unit 16 may be realized by the auxiliary storage unit 103 illustrated in FIG. 13, for example.

The driving data acquisition unit 11 acquires the driving data (see FIG. 12) for each driving condition from the driving data storage unit 2.

The in-cylinder pressure data acquisition unit 12 acquires in-cylinder pressure data among the driving data acquired by the driving data acquisition unit 11.

The heat release rate calculation unit 13 calculates the true heat release rate ROHRₜᵣᵤₑ for each driving condition based on the in-cylinder pressure data acquired by the in-cylinder pressure data acquisition unit 12. Specifically, the apparent heat release rate calculation unit 131 calculates the apparent heat release rate ROHRₐₚₚₐᵣₑₙₜ for each driving condition based on the in-cylinder pressure data acquired by the in-cylinder pressure data acquisition unit 12. The apparent heat release rate ROHRₐₚₚₐᵣₑₙₜ calculation method is as described above. In addition, the heat loss calculation unit 132 calculates the heat loss HL_{actual} based on the in-cylinder pressure data acquired by the in-cylinder pressure data acquisition unit 12 for each driving condition. The calculation method of the heat loss HL_{actual} is as described above. In addition, the true heat release rate calculation unit 133 calculates the true heat release rate ROHRₜᵣᵤₑ by adding the apparent heat release rate ROHRₐₚₚₐᵣₑₙₜ calculated by the apparent heat release rate calculation unit 131 and the heat loss HL_{actual} calculated by the heat loss calculation unit 132 for each driving condition.

The optimization calculation unit 14 identifies model parameters for each driving condition. Specifically, the Wiebe function parameter identification unit 141 executes the optimization calculation using the evaluation function F (see Equation 11) based on the true heat release rate ROHRₜᵣᵤₑ calculated by the heat release rate calculation unit 13 for each driving condition. The Wiebe function parameter identification unit 141 searches each value (optimum value) of the Wiebe function parameter that minimizes the evaluation function F while changing each value of the Wiebe function parameter. In addition, the heat loss model parameter identification unit 142 executes optimization calculation using an evaluation function F_{HL} (see equation 21) based on the heat loss HL_{actual} calculated by the heat loss calculation unit 132 for each driving condition. The heat loss model parameter identification unit 142 searches each value (optimum value) of the heat loss model parameter that minimizes the evaluation function F_{HL} while changing each value of the heat loss model parameter.

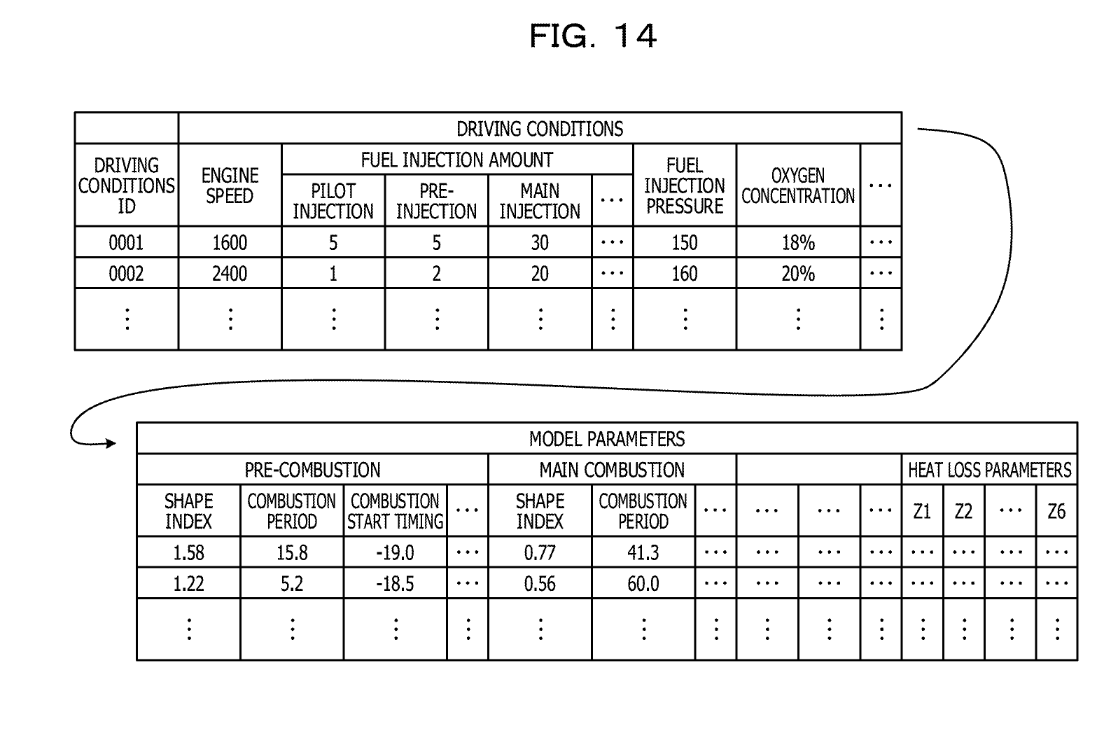

The model parameter housing unit 15 stores each optimum value of the model parameter obtained for each driving condition by the optimization calculation unit 14 in association with the driving condition ID in the model parameter storage unit 16. In this manner, each optimum value of the model parameter is calculated for each driving condition (for each driving condition ID) and stored in the model parameter storage unit 16. FIG. 14 is a diagram conceptually illustrating an example of data in the model parameter storage unit 16. In the example illustrated in FIG. 14, each optimum value of model parameters is associated with the data (driving condition parameters) illustrated in FIG. 12. That is, in the data illustrated in FIG. 14, each optimum value of model parameters is associated with each driving condition (each combination of driving condition parameters). In the example illustrated in FIG. 14, each optimum value of the Wiebe function parameters is obtained for each Wiebe function (that is, for each combustion mode such as pre-combustion and main combustion).

The model parameter housing unit 15 may calculate a relational expression (for example, a linear polynomial) representing the relationship between each optimum value of the model parameter and each driving condition, based on the data (see FIG. 14) in the model parameter storage unit 16. Specifically, the model parameter housing unit 15 calculates polynomial modeling information (for example, values of the respective coefficients β₁ to βₙ and the like to be described below) based on the data illustrated in FIG. 14. In this case, the model parameter housing unit 15 may store the polynomial modeling information in the model parameter storage unit 16 instead of the data illustrated in FIG. 14. In this case, compared with the case of holding the data (map data) illustrated in FIG. 14, the storage capacity in the model parameter storage unit 16 may be greatly reduced.

The polynomial modeling information may be generated as follows, for example. Based on the data (see FIG. 14) in the model parameter storage unit 16, the model parameter housing unit 15 may approximate the relationship between each optimum value of the Wiebe function parameter and each driving condition by using the following linear polynomial.

yⱼ=β₀+β₁E₁+ . . . +βₙEₙ (22)

β₀ is an intercept, β₁ to βₙ are coefficients, and E₁ to Eₙ are driving condition parameters (explanatory variables). n corresponds to the number of explanatory variables. yⱼ is the value of the Wiebe function parameter, and for each Wiebe function parameter, the polynomial of Equation 22 is used. According to the present example, since the relationship between the driving condition and the Wiebe function parameter is maintained under various driving conditions, the relationship may be represented by a function such as a polynomial or the like. In this way, it is possible to estimate the values of the respective Wiebe function parameters corresponding to arbitrary driving conditions with high accuracy.

Similarly, based on the data in the model parameter storage unit 16, the model parameter housing unit 15 may approximate the relationship between each optimum value of the heat loss model parameter and each driving condition by using the following linear polynomial.

zⱼ=β1₀+β1₁E₁+ . . . +β1ₙEₙ (23)

β1₀ is an intercept, β1₁ to β1ₙ are coefficients, and E₁ to Eₙ are driving condition parameters (explanatory variables). n corresponds to the number of explanatory variables. zⱼ is the value of the heat loss model parameter, and for each heat loss model parameter, the polynomial of Equation 23 is used. According to the present example, since the relationship between the driving condition and the heat loss model parameter is maintained under various driving conditions, the relationship may be represented by a function such as a polynomial or the like. In this way, it is possible to estimate the value of the heat loss model parameter corresponding to an arbitrary driving condition with high accuracy.

Although Equations 22 and 23 are linear polynomials, other polynomials such as quadratic polynomials or the like may be used.

By the way, in the data illustrated in FIG. 14, as described above, each optimum value of model parameters is associated with each driving condition (each combination of driving condition parameters). Therefore, if data on a large number of driving conditions is obtained, there is a high possibility of extracting values of model parameters conforming to certain arbitrary operating conditions. However, the driving conditions of the internal combustion engine vary greatly depending on the combination of the engine speed, the air quantity, the fuel injection pressure and the like. It is not realistic to derive each optimum value of model parameters under such various operating conditions.

On the other hand, in the case of obtaining polynomial modeling information using polynomials such as Equations 22 and 23 based on the data illustrated FIG. 14, it is possible to derive each optimum value of the model parameter under various driving conditions with a small amount of data. That is, the polynomial modeling information may include each value of coefficients β₀ to βₙ for each Wiebe function parameter and each value of coefficients β1₀ to β1ₙ for each heat loss model parameter and does not have to link each driving condition (each combination of driving condition parameters). Therefore, the data amount of the polynomial modeling information is overwhelmingly smaller than that of the data illustrated in FIG. 14. On the other hand, the polynomial modeling information may be used to accurately derive each optimum value of the model parameter over various operating conditions despite the small amount of data.

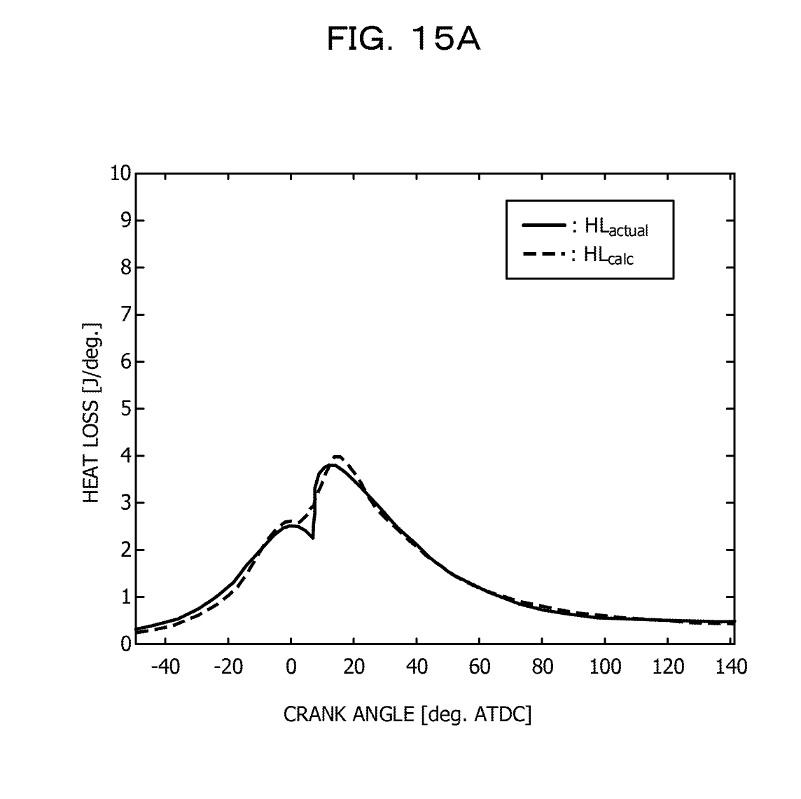

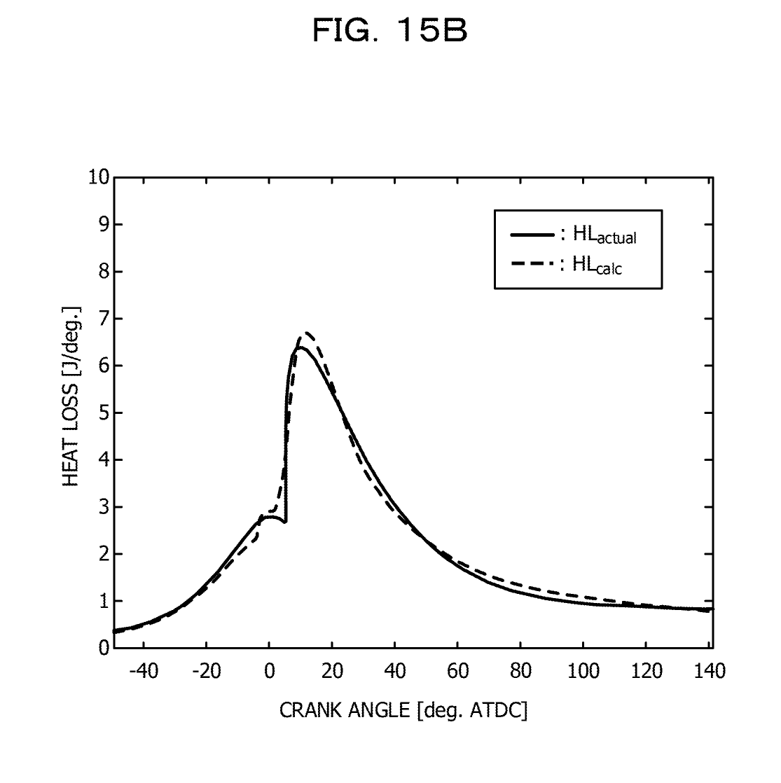

FIGS. 15A and 15B are explanatory diagrams of the effect of the identification results when using the heat loss model according to the present embodiment. Here, by using the above-described polynomial modeling information, different driving conditions are identified by using the heat loss model according to present example. FIGS. 15A and 15B are diagrams of identification results relating to different driving conditions, respectively. FIGS. 15A and 15B illustrates that based on the actually measured values, the adaptability of the heat loss HLcalc to the heat loss HL_{actual} is high and the heat loss model according to the present example is effective. As a more concrete evaluation, in the driving conditions according to FIG. 15A, the conformity is 91.1% and the RMSE is 0.034, and in the driving conditions according to FIG. 15B, the conformity is 96.8% and the RMSE is 0.034.

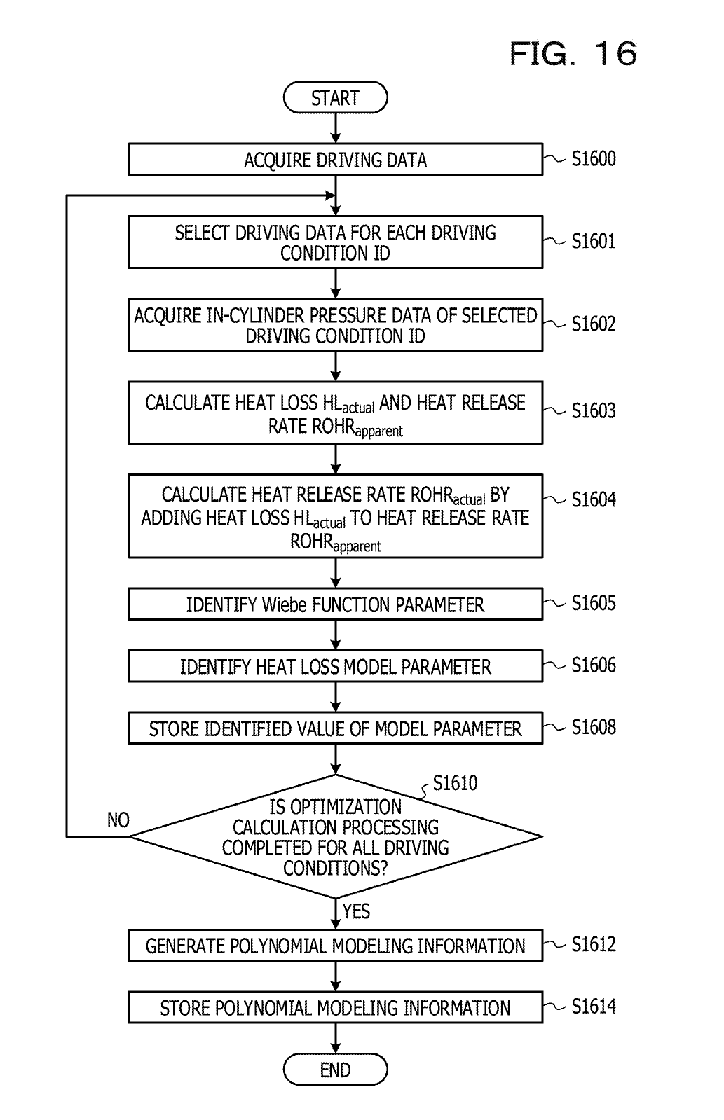

FIG. 16 is a flowchart illustrating an example of processing executed by the parameter identification device 10. The processing illustrated in FIG. 16 is executed offline, for example. In addition, the processing illustrated in FIG. 16 is executed, for example, for each driving condition with respect to driving data relating to a plurality of driving conditions in the driving data storage unit 2. The operating conditions are defined by combinations of the values of the above-described operating condition parameters.

In step S1600, the driving data acquisition unit 11 acquires driving data relating to one or more driving conditions (driving condition ID) of a current calculation target from the driving data storage unit 2. As described above, the driving data includes each value of the driving condition parameter and the in-cylinder pressure data for each driving condition ID (see FIG. 12).

In step S1601, the driving data acquisition unit 11 selects the driving data relating to one specific driving condition ID in a predetermined order (for example, ascending order of driving condition ID) from among the driving data relating to one or more driving condition IDs acquired in step S1600.

In step S1602, the in-cylinder pressure data acquisition unit 12 acquires in-cylinder pressure data among the driving data selected in step S1601.

In step S1603, the heat release rate calculation unit 13 calculates the heat loss HL_{actual} and the apparent heat release rate ROHRₐₚₚₐᵣₑₙₜ for each crank angle based on the in-cylinder pressure data acquired in step S1602.

In step S1604, the heat release rate calculation unit 13 calculates the heat release rate ROHRₜᵣᵤₑ for each crank angle by adding the heat loss HL_{actual} for each crank angle to the apparent heat release rate ROHRₐₚₚₐᵣₑₙₜ for each crank angle.

In step S1605, the Wiebe function parameter identification unit 141 of the optimization calculation unit 14 derives each value (optimum value) of the Wiebe function parameter that minimizes the evaluation function F (see, for example, Expression 11) based on the heat release rate ROHR acquired in step S1604.

In step S1606, the heat loss model parameter identification unit 142 of the optimization calculation unit 14 derives the optimum value of the heat loss model parameter based on the heat loss HL_{actual} and the heat loss model (see Equation 20) acquired in step S1603. That is, the heat loss model parameter identification unit 142 derives each value (optimum value) of the heat loss model parameter that minimizes the evaluation function F_{HL} (see Equation 21).

In step S1608, the model parameter housing unit 15 stores the values of the model parameters acquired in steps S1604 and S1606 in association with the current driving condition ID in the model parameter storage unit 16.

In step S1610, the model parameter housing unit 15 determines whether or not the optimization calculation processing has been completed for all of the one or more driving condition IDs acquired in step S1600. When the determination result is YES, the processing proceeds to step S1612. On the other hand, in a case where the determination result is NO, the processing illustrated FIG. 16 returns to step S1601, the driving data relating to one new driving condition ID is selected, and the processing of steps S1604 to S1608 are executed.

In step S1612, the model parameter housing unit 15 generates the polynomial modeling information based on each value (each value for each driving condition ID) in the model parameter storage unit 16 stored in step S1608. The method of generating the polynomial modeling information is as described above.

In step S1614, the model parameter housing unit 15 stores the polynomial modeling information in the model parameter storage unit 16.

According to the processing illustrated in FIG. 16, it is possible to obtain the polynomial modeling information from which the value of the model parameter may be derived under various driving conditions with high accuracy by acquiring driving data covering various driving conditions from the driving data storage unit 2. In this way, it is possible to estimate the value of each model parameter corresponding to an arbitrary driving condition.

In the processing illustrated in FIG. 16, the heat loss model parameters have been identified after the identification of the Wiebe function parameters but may be reversed. That is, the Wiebe function parameters may be identified after identification of the heat loss model parameters. This is because the identification of the Wiebe function parameters and the identification of the heat loss model parameters are independent of each other.

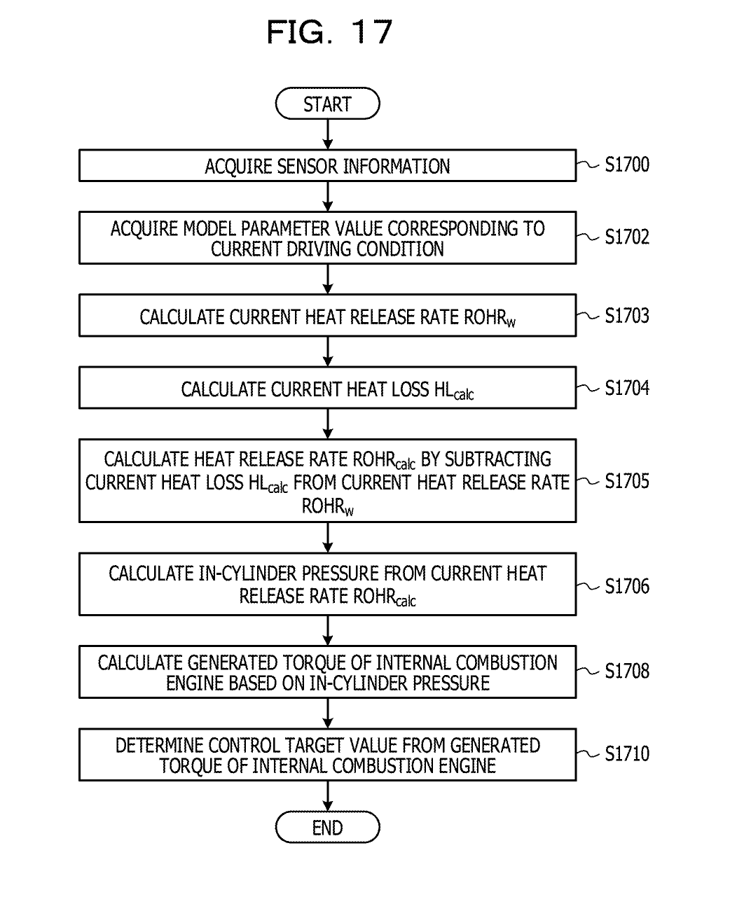

Next, with reference to FIG. 11 again, the engine control device 30 will be described with reference to FIG. 17.

The engine control device 30 controls various actuators of the engine system 4. As illustrated in FIG. 11, the engine control device 30 includes a model parameter acquisition unit 32 (an example of a determination unit), a model function calculation unit 34, an engine torque calculation unit 36 (an example of an in-cylinder pressure calculation unit), and a control value calculation unit 38 (an example of a control unit). The model function calculation unit 34 includes a Wiebe function value calculation unit 341 (an example of a first calculation unit), a heat loss model value calculation unit 342 (an example of a second calculation unit), and a heat release rate estimated value calculation unit 343. The hardware configuration of the engine control device 30 may be the same as the hardware configuration of the parameter identification device 10 illustrated in FIG. 13. The model parameter acquisition unit 32, the model function calculation unit 34, the engine torque calculation unit 36, and the control value calculation unit 38 may be realized by the control unit 101 illustrated in FIG. 13 executing one or more programs in the main storage unit 102.

FIG. 17 is a flowchart illustrating an example of processing executed by the engine control device 30. The processing illustrated in FIG. 17 is executed, for example, at the time of actual operation of the engine system 4.

In step S1700, the model parameter acquisition unit 32 acquires sensor information indicating the current state of the internal combustion engine from the sensor group 6. The information indicating the current state of the internal combustion engine is, for example, each value of the current driving condition parameter (information indicating the current driving condition of the internal combustion engine) and a current crank angle.

In step S1702, the model parameter acquisition unit 32 determines the current driving condition based on the sensor information obtained in step S1700 and acquires each value of the model parameter corresponding to the current driving condition from the model parameter storage unit 16. For example, in a case where the above-described polynomial modeling information is stored in the model parameter storage unit 16, the model parameter acquisition unit 32 acquires the value of each model parameter by substituting each value of the current driving condition parameter into the polynomial relating to each model parameter.

In step S1703, the Wiebe function value calculation unit 341 of the model function calculation unit 34 calculates the heat release rate ROHR_{w} at the current crank angle based on the value of each Wiebe function parameter acquired by the model parameter acquisition unit 32.

In step S1704, the heat loss model value calculation unit 342 of the model function calculation unit 34 calculates the heat loss HL_{calc} at the current crank angle based on the value of each heat loss model parameter acquired by the model parameter acquisition unit 32.

In step S1705, the heat release rate estimated value calculation unit 343 of the model function calculation unit 34 calculates the heat release rate ROHR_{calc} at the current crank angle. Specifically, the heat release rate estimated value calculation unit 343 calculates the current heat release rate ROHR_{calc} by subtracting the heat loss HL_{calc} calculated by the heat loss model value calculation unit 342 from the heat release rate ROHR_{w} calculated by the Wiebe function value calculation unit 341.

In step S1706, the engine torque calculation unit 36 calculates the current in-cylinder pressure based on the current value calculated by the ROHR_{calc} calculated by the model function calculation unit 34 in step S1704. Calculation of the in-cylinder pressure may be realized by using the relational expression illustrated in Expression 9 as described above. Specifically, the in-cylinder pressure may be calculated by using the following relational expression.

$${ROHR}_{calc} = ( \frac{1}{γ - 1} ) V \frac{dP}{d θ} + ( \frac{γ}{γ - 1} ) P \frac{dV}{d θ} \qquad ( 24 )$$

In step S1708, the engine torque calculation unit 36 calculates the current torque generated by the internal combustion engine based on the calculated value of the in-cylinder pressure calculated in step S1706. The torque generated by the internal combustion engine may be calculated as the sum of the torque due to the in-cylinder pressure, the inertia torque, and the like.

In step S1710, the control value calculation unit 38 calculates a control target value to be given to the engine system 4 based on the current calculated value of the torque generated by the internal combustion engine calculated by the engine torque calculation unit 36 in step S1708. For example, the control value calculation unit 38 may determine the control target value so that an appropriate drive torque is realized based on the difference between a requested drive torque and a current calculated value of the torque generated by the internal combustion engine obtained in step S1708. The control target value may be, for example, a target value of a throttle opening degree, a target value of a fuel injection amount, or the like. The appropriate drive torque may be a driver-requested drive torque corresponding to a vehicle speed and an accelerator opening degree, a requested drive torque for assisting the driver driving the vehicle, or the like. The appropriate drive torque for assisting the driver driving the vehicle is determined based on information from a radar sensor or the like, for example. The appropriate drive torque for assisting the driver driving the vehicle may be, for example, a drive torque for traveling at a predetermined vehicle speed, a drive torque for following a preceding vehicle, a drive torque for limiting the vehicle speed so as not to exceed a limited vehicle speed, and the like.

According to the process illustrated in FIG. 17, the engine control device 30 may control the feedback of the engine system 4, for example, based on the difference between an appropriate drive force and the calculated value of the torque generated by the internal combustion engine based on the combination Wiebe function. As described above, the accuracy of the calculated value of the generated torque of the internal combustion engine based on the Wiebe function is higher as the accuracy of identifying each model parameter of the Wiebe function is high as described above. Therefore, it is possible to accurately control the engine system 4 by using the high-accuracy calculated value of the torque generated by the internal combustion engine. In this way, for example, fuel does not have to be excessively injected into the cylinder, the engine performance is improved, and fuel consumption and drivability are improved. In this manner, the data (data in the model parameter storage unit 16) obtained by the parameter identification device 10 may be effectively used for improving the performance of the engine control system.

The engine control device 30 illustrated in FIG. 11 is mounted on the in-vehicle control system 1 together with all the constituent elements of the parameter identification device 10 but is not limited thereto. For example, the engine control device 30 may be mounted on the in-vehicle control system 1 together with the model parameter storage unit 16 which is a part of the parameter identification device 10. That is, the in-vehicle control system 1 may not include constituent elements other than the model parameter storage unit 16 among the constituent elements of the parameter identification device 10. In this case, the above-described data may be stored in advance in the model parameter storage unit 16 (before factory shipment).

In the in-vehicle control system 1 illustrated in FIG. 11, the engine system 4 is an example of a vehicle drive device to be controlled but is not limited thereto. For example, the vehicle drive device to be controlled may include a transmission, an electric motor, a clutch, and the like in addition to or instead of the engine system 4.

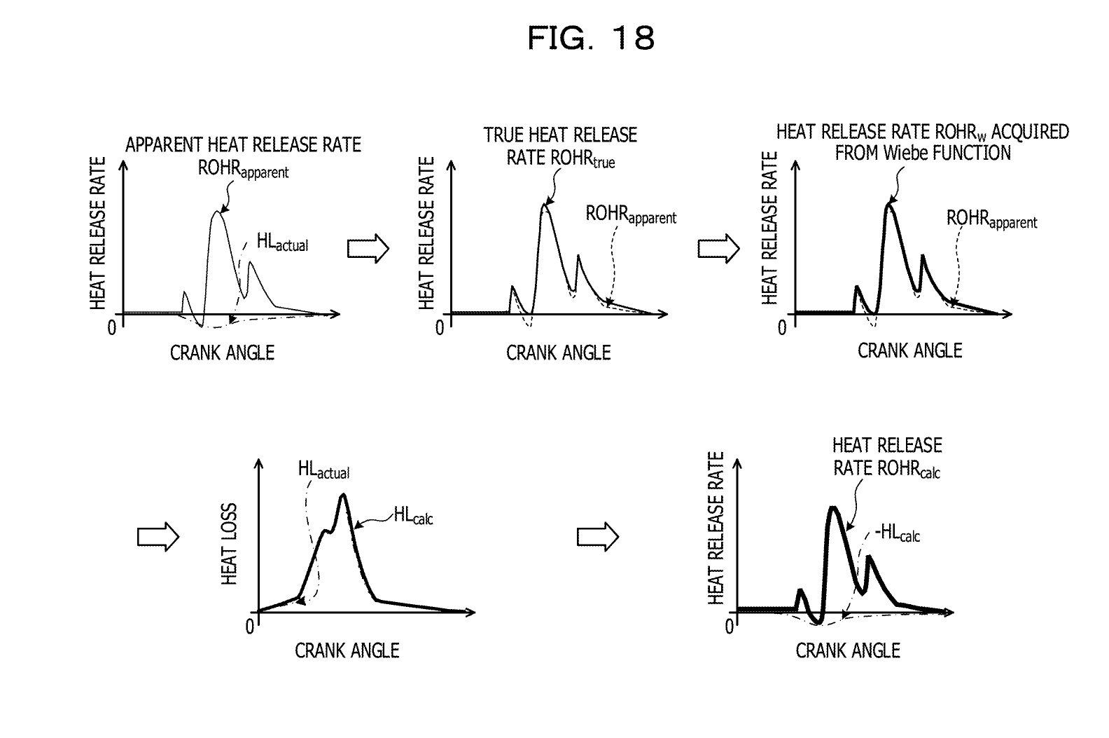

Next, with reference to FIG. 18, the flow and effect of the operations of the parameter identification device 10 and the engine control device 30 in the in-vehicle control system 1 will be outlined.

FIG. 18 is an explanatory diagram for schematically describing a general flow of operations of the parameter identification device 10 and the engine control device 30 in the in-vehicle control system 1 described above. FIG. 18 illustrates each waveform (a relationship between the crank angle and the heat release rate, and the like) relating to the portion X1 in FIG. 4. In FIG. 18, like the above-described FIG. 5, an apparent relationship (first relationship) between the crank angle and the apparent heat release rate ROHR is illustrated firstly in the order of the arrows from the upstream side. In addition, in FIG. 18, the relationship between the crank angle and the true heat release rate ROHRₜᵣᵤₑ (second relationship) is illustrated secondly in the order of the arrows. In addition, in FIG. 18, the relationship between the crank angle and the heat release rate ROHR_{w} from the Wiebe function (third relationship), and the relationship with the first relationship are illustrated thirdly in the order of the arrows. In addition, in FIG. 18, a waveform representing the relationship between the crank angle and the heat loss HL_{actual} (here, referred to as “fifth relationship”) is illustrated fourthly by a dashed line in the order of the arrows. In addition, in FIG. 18, a waveform representing the relationship between the crank angle and the heat loss HL_{calc} (here, referred to as “sixth relationship”) is illustrated fourthly by a solid line in the order of the arrows. In addition, in FIG. 18, the relationship between the crank angle and the heat release rate ROHR_{calc} (here, referred to as “fourth relationship”) is illustrated fifthly in the order of the arrows. In FIG. 18, in the waveforms representing the first relationship and the fourth relationship, for reference, a waveform representing the relationship between the crank angle and the negative heat loss −HL_{actual} and a waveform representing the relationship between the crank angle and the negative heat loss −HL_{calc} are superimposed with dashed lines, respectively. In addition, in FIG. 18, for reference, in the waveforms representing the second relationship and the third relationship, a waveform representing the first relationship is superimposed by a dotted line.

First, in the parameter identification device 10, for each driving condition, the value of the actual heat loss HL_{actual} based on the fifth relationship is added to the value of the apparent heat release rate ROHRₐₚₚₐᵣₑₙₜ based on the first relationship for each crank angle. As a result, the second relationship (the relationship between the crank angle and the true heat release rate ROHRₜᵣᵤₑ) may be obtained. Next, the Wiebe function parameters are identified for each driving condition. As illustrated in FIG. 18, the third relationship obtained from the Wiebe function by using the value of the identified parameter reproduces the second relationship with high accuracy. In addition, in the parameter identification device 10, the heat loss model parameters are identified for each driving condition.

The engine control device 30 subtracts the value of the heat loss HLcalc based on the sixth relationship from the value of the heat release rate ROHR_{w} based on the third relationship for each crank angle with respect to each driving condition. As a result, as illustrated in FIG. 18, the fourth relationship (relationship between crank angle and heat release rate ROHR_{calc}) is obtained. The fourth relationship obtained as described above, as schematically illustrated in FIG. 18, accurately reproduces the first relationship. Accordingly, the accuracy of the calculated value of the in-cylinder pressure of the internal combustion engine calculated based on the fourth relationship and the calculated value of the generated torque based on the fourth relationship is increased in the engine control device 30.

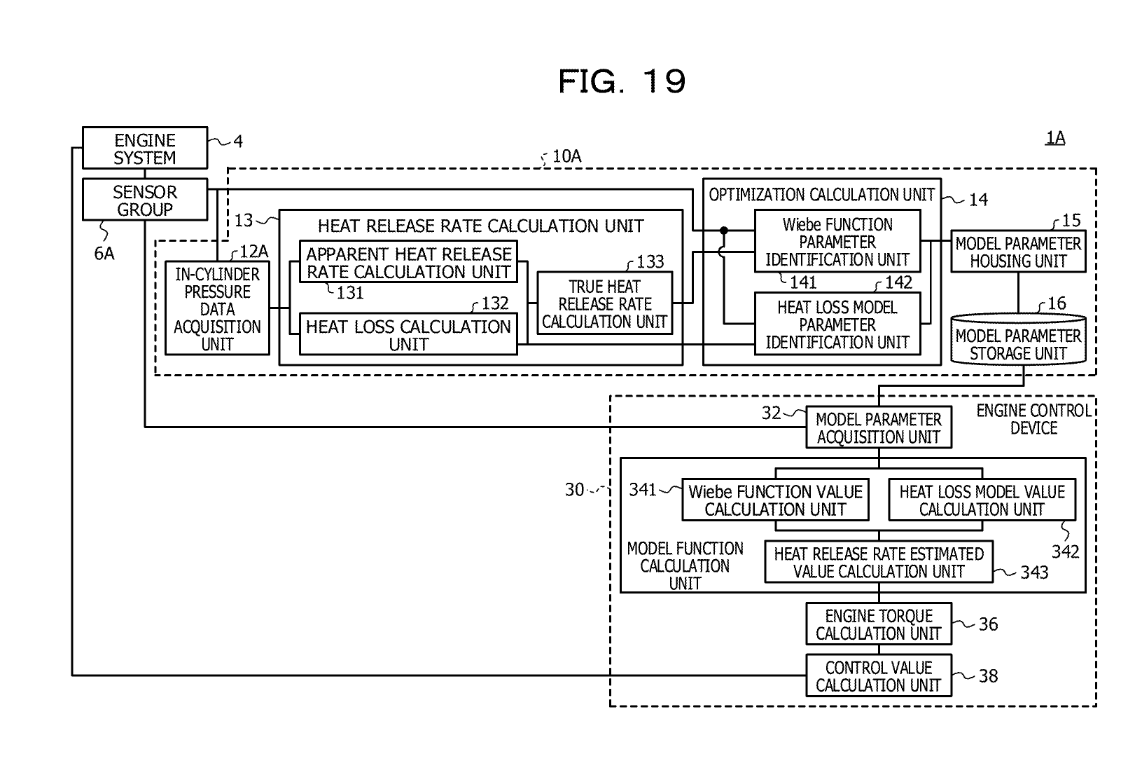

Next, an alternative example to the in-vehicle control system 1 will be described with reference to FIG. 19.

FIG. 19 is a diagram illustrating another example of the in-vehicle control system including the parameter identification device.

An in-vehicle control system 1A illustrated in FIG. 19 differs from the in-vehicle control system 1 illustrated in FIG. 11 in that the driving data acquisition unit 11 is omitted. In addition, the in-vehicle control system 1A illustrated in FIG. 19 differs from the in-vehicle control system 1 illustrated in FIG. 11 in that the parameter identification device 10 is replaced by a parameter identification device 10A and the sensor group 6 is replaced by a sensor group 6A. Constituent elements of the in-vehicle control system 1A illustrated in FIG. 19, which may be the same as the in-vehicle control system 1 illustrated in FIG. 11, are denoted by the same reference numerals in FIG. 19, and the description thereof is omitted.

The sensor group 6A naturally includes an in-cylinder pressure sensor, which is different from the above-described sensor group 6 that does not have to include an in-cylinder pressure sensor.

The parameter identification device 10A differs from the parameter identification device 10 in that the in-cylinder pressure data acquisition unit 12 is replaced with an in-cylinder pressure data acquisition unit 12A. The in-cylinder pressure data acquiring unit 12A acquires the same data as the in-cylinder pressure data acquisition unit 12 but differs from the in-cylinder pressure data acquisition unit 12 that acquires the same data from the driving data storage unit 2 in that the in-cylinder pressure data acquisition unit 12A acquires the same data from the sensor group 6A (in-cylinder pressure sensor).

According to the in-vehicle control system 1A illustrated in FIG. 19, since the sensor group 6A includes the in-cylinder pressure sensor, the processing illustrated in FIG. 16 may be executed also in a vehicle-mounted state (that is, the state after shipment of the vehicle). That is, according to the in-vehicle control system 1A illustrated in FIG. 19, in the vehicle-mounted state, the data (including the case of polynomial modeling information) in the model parameter storage unit 16 may be updated periodically or irregularly. In this way, even in a case where there are individual differences in the characteristics of the internal combustion engine, it is possible to modify the model parameters according to the individual differences. In addition, even in a case where the characteristics of the internal combustion engine change over time, it is possible to update the model parameters.

Each of the examples has been described in detail but is not limited to the specific example, and various modifications and changes are possible within the scope described in the claims. In addition, it is also possible to combine all or a plurality of constituent elements of the example described above.

For example, in the example described above, the heat loss model is expressed by Equation 20 as a combination of the first heat loss model and the second heat loss model, but not limited thereto. For example, like the Wiebe function, the second heat loss model may be expressed by combining a plurality of HL₂(θ). In addition, HL₁(θ) may be set to HL₁(θ)=0 when θ>z₆. Furthermore, in the example described above, as a preferred example, a heat loss model combining the first heat loss model and the second heat loss model is used, but only one thereof may be used. For example, a heat loss model including only the second heat loss model may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made thereto without departing from the spirit and scope of the invention.

What is claimed is:

1. An information processing apparatus comprising:
a memory; and
a processor coupled to the memory and configured to:
add a positive value to a first heat release rate based on an actually measured value of an in-cylinder pressure of an internal combustion engine for each crank angle of the internal combustion engine to derive a second heat release rate according to the crank angle;
set a plurality of first model parameters of a Wiebe function which models a heat release rate based on the second heat release rate;
store the first model parameters in the memory; and
output the first model parameters from the memory in order to calculate a torque which controls the internal combustion engine at the time of actual operation of the internal combustion engine.

2. The information processing apparatus according to claim 1,
wherein the positive value changes according to the crank angle.

3. The information processing apparatus according to claim 2,
wherein the manner of change of the positive value according to the crank angle corresponds to the manner of change of a heat loss according to the crank angle based on the actually measured value of the in-cylinder pressure.

4. The information processing apparatus according to claim 1,
wherein the processor sets a plurality of second model parameters of a heat loss model.

5. The information processing apparatus according to claim 4,
wherein the heat loss model is expressed by using the in-cylinder pressure and an in-cylinder volume when an intake valve is closed and a heat loss when an exhaust valve is opened.

6. The information processing apparatus according to claim 5,
wherein the heat loss model includes a combination of a first function that models a heat loss before the start of combustion and after the start of combustion and a second function that models a heat loss after the start of combustion.

7. The information processing apparatus according to claim 6,
wherein the second function is a function that is expressed by a Wiebe function.

8. The information processing apparatus according to claim 7,
wherein the plurality of second model parameters include a heat loss period after the start of combustion and a combustion start timing.

9. The information processing apparatus according to claim 4,
wherein the processor sets the plurality of first model parameters for each driving condition and sets the plurality of second model parameters for each driving condition.

10. The information processing apparatus according to claim 9,
wherein the processor:
derives a first relational expression between a plurality of driving condition parameters representing the driving condition and the plurality of first model parameters based on values of the plurality of first model parameters; and
derives a second relational expression between the plurality of driving condition parameters and the plurality of second model parameters based on values of the plurality of second model parameters.

11. The information processing apparatus according to claim 10,
wherein each of the first relational expression and the second relational expression is a linear polynomial.

12. An in-vehicle control system comprising:
a vehicle drive device;
a crank angle sensor; and
a processor;
wherein the processor is configured to:
calculate a heat release rate by combustion in a cylinder of an internal combustion engine based on information from the crank angle sensor and a Wiebe function;
calculate a heat loss in the cylinder of the internal combustion engine based on the information from the crank angle sensor and a heat loss model;
calculate an in-cylinder pressure based on the heat release rate and the heat loss; and
control the vehicle drive device based on the calculated in-cylinder pressure.

13. The in-vehicle control system according to claim 12, further comprising:
a first memory that stores first information from which the plurality of first model parameters that are a plurality of first model parameters of the Wiebe function and are set based on a second heat release rate for each crank angle obtained by adding a second heat loss for each crank angle based on an actually measured value of an in-cylinder pressure to a first heat release rate for each crank angle based on the actually measured value of the in-cylinder pressure are derived,
wherein the processor calculates the heat release rate based on the plurality of first model parameters based on the first information of the first memory.

14. The in-vehicle control system according to claim 12, further comprising:
a second memory that stores second information from which a plurality of second model parameters that are a plurality of second model parameters of the heat loss model and are set based on actually measured values of the in-cylinder pressure are derived,
wherein the processor calculates a first heat loss based on the plurality of second model parameters based on the second information of the second memory.

15. The in-vehicle control system according to claim 13,
wherein the first information is a first relational expression between driving conditions and the plurality of first model parameters, and
the processor calculates the heat release rate by using the plurality of first model parameters derived from the first relational expression according to the driving conditions.

16. The in-vehicle control system according to claim 14,
wherein the second information is a second relational expression between driving conditions and the plurality of second model parameters, and
the processor calculates the first heat loss by using the plurality of second model parameters derived from the second relational expression according to the driving conditions.

17. The in-vehicle control system according to claim 12,
wherein the processor calculates the in-cylinder pressure based on a value obtained by subtracting the first heat loss from the heat release rate.

18. A function parameter setting method comprising:
Adding, by a computer, a positive value to a first heat release rate based on an actually measured value of an in-cylinder pressure of an internal combustion engine for each crank angle of the internal combustion engine to derive a second heat release rate according to the crank angle;
setting a plurality of first model parameters of a Wiebe function which models a heat release rate based on the second heat release rate;
storing the first model parameters in a memory; and
outputting the first model parameters from the memory in order to calculate a torque which controls the internal combustion engine at the time of actual operation of the internal combustion engine.

19. The function parameter setting method according to claim 18,
wherein the positive value changes according to the crank angle.

20. The function parameter setting method according to claim 18, further comprising setting a plurality of second model parameters of a heat loss model.
